(19) United States
(12) Patent Application Publication
(10) Pub. No.: US 2016/0025189 A1
(43) Pub. Date: Jan. 28, 2016

(54) VEHICLE TRANSMISSION

(71) Applicant: ZF FRIEDRICHSHAFEN AG, Friedrichshafen (DE)

(72) Inventors: Johannes KALTENBACH, Friedrichshafen (DE); Peter ZIEMER, Tettnang (DE); Kai BORNTRÄGER, Langenargen (DE)

(73) Assignee: ZF FRIEDRICHSHAFEN AG, Friedrichshafen (DE)

(21) Appl. No.: 14/774,269

(22) PCT Filed: Feb. 12, 2014
(86) PCT No.: PCT/EP2014/052683

§ 371 Date: Sep. 10, 2015

(30) Foreign Application Priority Data
Mar. 12, 2013 (DE) 10 2013 204 172.1

(51) Int. Cl. F16H 3/66; F16H 3/00

(52) U.S. Cl. CPC F16H 3/66; F16H 3/006; F16H 2003/445

(57) ABSTRACT

A vehicle transmission having first and second transmission input shafts (GE1, GE2) and having at least three planetary gear sets (PG1, PG2, PG3). A sub-transmission (TG1, TG2) is allocated to each of first and second transmission input shafts (GE1, GE2) and one of first and second sub-transmissions (TG1, TG2) comprises at least the first planetary gear set (PG1), and the other of first and second sub-transmissions (TG1, TG2) comprises at least the second planetary gear set (PG2). To ensure that the vehicle transmission is economically manufactured and useful for both conventional and hybrid drive trains, a provision is that the transmission input shafts (GE1, GE2) be effectively connected or effectively connectable with the planetary gear sets (PG1, PG2, PG3), that it be possible to variably activate first and second sub-transmissions (TG1, TG2) for implementing multiple gears, and that one of the gears be shiftable as a direct-drive gear.

This application is a National Stage completion of PCT/EP2014/052683 filed Feb. 12, 2014, which claims priority from German patent application serial no. 10 2013 204 172.1 filed Mar. 12, 2013.

### FIELD OF THE INVENTION

The invention relates to a vehicle transmission.

### BACKGROUND OF THE INVENTION

Increasing demands on the power and the fuel consumption of vehicles have resulted in a larger number of gears in the transmissions, both for passenger automobiles and also for utility vehicles. In addition, the installation space available in motor vehicles for the transmission is limited and its weight is to be increased only little or not at all in spite of the increased number of gears. In addition, transmissions are required which enable gear shifting without interruption of traction force and are usable with relatively little expenditure in various drive concepts.

Vehicle transmissions having two input shafts are known, in particular double-clutch transmissions. In these transmissions, two input clutches, which are generally friction-locked and each have multiple gear sets, form a partial transmission having one power path in each case, which are alternately preselected or active, respectively, with respect to the gears to be used next, so that by way of overlapping the disengaging and engaging of the two input clutches, a power-shiftable shift sequence is implemented in the sequential change.

Double-clutch transmissions can also be designed as an auxiliary transmission. Such auxiliary transmissions have a multi-gear main group, usually in lay-shaft construction, and an upstream group active as a split transmission and/or a downstream group active as a range transmission in lay-shaft or planetary construction. A multiplication of the number of gears of the main transmission can thus be achieved.

Double-clutch transmissions in planetary construction are also already known. DE 10 2004 014 081 A1 discloses such a double-clutch transmission having only one transmission input shaft, in which three planetary gear sets and two friction-locked and multiple formfitting shift elements are arranged, wherein the friction-locked shift elements are active for switching in various power paths and the formfitting shift elements are active for setting various transmission steps in the power paths, and in which a total of seven forward gears and one reverse gear are usable. In a partial range of the gears, gear changes without traction force interruption can be carried out by means of the friction-locked shift elements.

A hybrid drivetrain for a vehicle having an internal combustion engine and one or more electric machines is known from DE 10 2010 028 026 A1, in which a transmission of lay-shaft construction has two partial transmissions. One electric machine, or one electric machine in each case, respectively, is associated with one or both partial transmissions. At least one electric machine of a partial transmission is operationally connectible via a formfitting shift element to the internal combustion engine.

DE 10 2012 201 366 A1 (no prior publication) of the applicant discloses a hybrid drivetrain for a motor vehicle, having an internal combustion engine and at least one electric machine, and in which a transmission has at least one transmission input shaft, one transmission output shaft, and three planetary gear sets, wherein two power paths or partial transmissions, each having a fixed input transmission ratio, are formed between a drive and the second planetary gear set, and in which the first planetary gear set is associated with the first or the second power path. The electric machine active for travel drive is associated with the first power path and can be operationally connected via a claw clutch or claw brake with the transmission input shaft for the internal combustion engine, respectively. Furthermore, the second planetary gear set is connectable to the first and second power path. The third planetary gear set is in turn connectable to the second power path and the second planetary gear set and has a continuous drive connection on the output side to the transmission output shaft.

To implement six to eight sequentially power-shiftable forward gears, seven to nine shift elements, which are preferably embodied as formfitting, are arranged, wherein the shift elements are predominantly combined to form double-sided shift elements or shift packets each having two shift settings, which can be actuated alternately by an actuator. In a possible, geometrically stepped shift scheme of this transmission, the claw clutch or claw brake, which connects the electric machine active in the travel drive to the transmission input shaft, is sequentially disengaged and engaged. In an engaged clutch state, travel operation by the internal combustion engine results in the odd gears. In a disengaged clutch state, travel operation by the electric motor results in the odd gears and travel operation by the internal combustion engine results in the even gears. During the gear changes, a load shift takes place via the gears driven by the electric motor as support gears.

### SUMMARY OF THE INVENTION

Against this background, the invention is based on the object of providing a vehicle transmission having multiple partial transmissions and power paths, which has a comparatively high number of gears, which is cost-effective to produce because of its structure, and is usable both for conventional and also for at least partially power-shiftable hybrid drivetrains.

The achievement of this object results from the features, advantageous embodiments and refinements of the invention as described below.

The invention is based on the finding that a vehicle transmission which has multiple planetary gear sets, which can be coupled to one another, is operable in an internal-combustion-engine drivetrain and in a hybrid drivetrain by a suitable attachment of the planetary gear sets to two transmission input shafts, wherein the two transmission input shafts can be coupled, via disconnecting clutches or disconnecting brakes, to the drive machine or the drive machines. The planetary gear sets enable a high number of gears in a compact construction, which functions with relatively few gear levels. Two transmission input shafts can be used in particular to form a double-clutch transmission having two independent power paths, so that a power-shiftable sequential gear sequence is implementable. By replacing one of the two disconnecting clutches with an electric machine active for travel drive, a hybrid drive can be implemented. A shiftable coupling of the two power paths can additionally expand the transmission ratio and drive possibilities.

Accordingly, the invention is directed to a vehicle transmission, having a driveshaft, having a first and a second transmission shaft, with each of which a disconnecting element is associated indirectly or directly, having a main shaft, having an output shaft, and having at least a first, second, and third planetary gear set, which have as elements in each case at least one ring gear, a sun gear, and a planet carrier having planetary gears, and having multiple shift elements for shifting gear transmission ratios or for shifting drive connections, wherein one partial transmission is associated with each of the two transmission input shafts, and in which one of the two partial transmissions has at least the first planetary gear set and the other of the two partial transmissions has at least the second planetary gear set.

To achieve the stated object, the invention additionally provides in this vehicle transmission,
that the first transmission input shaft is connectable on the drive side via a first disconnecting element, which is designed as a clutch, to the driveshaft,
that the first transmission input shaft is connectable on the output side to the main shaft and is operationally connectable to one or both of the second and third planetary gear sets,
that the second transmission input shaft is connectable on the drive side indirectly or directly, via a second disconnecting element, either to the driveshaft or to the first transmission input shaft, wherein the disconnecting element is designed as a clutch,
or that the second transmission input shaft is connected on the drive side directly to the driveshaft, wherein a second disconnecting element is designed as a brake, by means of which one of the elements of the first planetary gear set can be fixed on a rotationally-fixed component or disengaged therefrom,
that the second transmission input shaft is connectable or connected indirectly or directly on the output side to another one of the elements of the first planetary gear set,
that the main shaft is connected either to a drive-side element of the third planetary gear set and an output-side element of the third planetary gear set is connected to the output shaft,
or that the main shaft is connected directly to the output shaft and to the drive-side element of the third planetary gear set,
and at least eight sequentially shiftable forward gears are shiftable by means of the two partial transmissions, wherein one of these forward gears is a direct gear.

A vehicle transmission is provided by this design, which can both be installed in a hybrid drivetrain and is also usable as a conventional power-shift transmission, wherein a relatively large number of gears is combined with a comparatively simple and compact structure. The gears of the various embodiments of this transmission are completely or at least largely power-shiftable, so that more comfortable travel operation results. The transmission according to the invention has two input shafts, which, with one of the first two planetary gear sets, form two power paths or partial transmissions which are independent from one another, wherein a gear can be preselected in the respective load-free partial transmission, while the respective other partial transmission transmits the presently applied torque. Therefore, two load paths independent of one another are shiftable between the drive and the second planetary gear set. A third planetary gear set arranged downstream of the two power paths or partial transmissions is flexibly usable in operational connection with the two partial transmissions individually or together.

The transmission structure is operable as a two-input-shaft transmission, for example, having two input friction clutches or one input clutch and one input brake for selectively switching in the power paths or partial transmissions, wherein a drive torque of an internal combustion engine is transmitted to the respective partial transmission. However, it is also possible that one partial transmission is directly drivable by an electric machine, wherein one of the two friction elements can be replaced by a formfitting clutch. One or more reverse gear steps are implementable in a hybrid drivetrain by a rotational direction reversal of the electric drive.

In the case of a conventional, solely internal-combustion-engine drive, a reversal gear set can be provided for a rotational direction reversal to implement reverse gear transmission ratios and can be installed at various points in the transmission structure. Furthermore, the arrangement enables coupling of the two partial transmissions to one another if needed, which is advantageous in particular for an implementation of direct gears with low expenditure. The highest gear is preferably shiftable as a direct gear. In addition, an expansion of the basic operation using an additional transmission group is possible. The vehicle transmission according to the invention is therefore implementable very flexibly in a hybrid drivetrain, in a double-clutch transmission drivetrain, in an auxiliary transmission drivetrain, or in a combination thereof, both in the field of passenger automobiles and also in the field of utility vehicles.

According to a first embodiment of the invention, it can be provided that the vehicle transmission is designed as a double-clutch transmission, wherein the two transmission input shafts are arranged coaxially to one another, wherein the first and second disconnecting elements are designed as friction clutches and are connected in a rotationally-fixed manner to the driveshaft on the input side and are each operationally connected or operationally connectable on the output side via one of the transmission input shafts to the first or second partial transmission, wherein one group of even or odd gears is associated with each of the two partial transmissions and the gears are at least predominantly sequentially power-shiftable.

Accordingly, the vehicle transmission can be embodied as a double-clutch transmission having two partial transmissions in planetary construction. The driveshaft, the double clutch having the two transmission input shafts, the main shaft, and also the output shaft and the planetary gear sets, which can be arranged axially between the driveshaft and the output shaft, are preferably located in a compact, coaxial arrangement, in which multiple shaft levels are located radially one above another, on which shift elements are arranged, which are used for the variable coupling of elements or shafts of the gear sets.

The transmission structure enables, for example, a gear sequence, in which the gears are stepped strictly geometrically i.e., with difference of the highest velocity in the gears increasing in the shift sequence. The load transmission from the respective active gear into the following gear can be performed in each case by overlapping disengaging and engaging of the two friction clutches, wherein gear changes free of traction force interruption are implementable.

An arrangement for such a double-clutch transmission, which is considered to be an advantageous basic gear set, can be implemented in that three planetary gear sets are arranged, which are shiftable via a first, second, and third shift element each having two shift settings and a fourth shift element having one shift setting, and that the main shaft is directly connected to the output shaft. In this case, in the first planetary gear set, the ring gear is connected to the second transmission input shaft, the sun gear is permanently fixed on a rotationally-fixed component, and the planet carrier is alternately connectable to the ring gear or the planet carrier of the second planetary gear set via the second shift element. In the second planetary gear set, the ring gear is connectable via the first shift element to the first transmission input shaft, the sun gear is permanently fixed on a rotationally-fixed component, and the planet carrier is connectable via the third shift element to the planet carrier of the third planetary gear set. Furthermore, it is provided that, in the third planetary gear set, the ring gear is permanently fixed on a rotationally-fixed component, the sun gear is connectable via the third shift element to the planet carrier of the second planetary gear set and is connectable via the first shift element to the first transmission input shaft, and the planet carrier is connected to the output shaft. At least eight forward gears are shiftable by this construction, which are sequentially power-shiftable via the first and second disconnecting element, wherein the eighth gear is implementable as a direct gear, which is shiftable by a direct connection of the first transmission input shaft to the main shaft and the output shaft via the fourth shift element.

It is to be noted here that a shift element can comprise both a single shift device and also multiple shift devices, which are assembled into a packet. A shift setting is understood as a shift position of a shift element, in which a friction-locked connection of two components exists or is produced by the shift element. A shift element having two shift settings can accordingly alternately engage or disengage a first or a second friction-locked connection. A shift element can additionally have a neutral setting, in which no shift connection is implemented. The shift elements can be designed as cost-effective, formfitting claw shift elements.

A compact eight-gear double-clutch transmission having an optional direct gear is implemented by the arrangement of this basic gear set. The arrangement accordingly enables eight power-shiftable forward gears using three planetary gear sets and using four shift elements, which have a total of seven shift settings. The gear transmission ratios are preferably, but not necessarily, geometrically stepped.

In this basic gear set, the second planetary gear set is associated with the first partial transmission defined by the first friction clutch and the first transmission input shaft, the first planetary gear set is associated with the second partial transmission defined by the second friction clutch and the second transmission input shaft. Since one of the elements, namely the sun gear, is permanently fixed on a rotationally-fixed component in the first and the second planetary gear sets, and a second element in the first and the second planetary gear sets, namely the ring gear, is connected or connectable to the first or second transmission input shaft, respectively, the two first planetary gear sets act as input constants of the partial transmission thereof, having a fixed transmission ratio in each case.

A power-shiftable sequential gear sequence results by combining the planetary gear set transmission ratios such that the respective following gear can be preselected in a load-free manner and the load transition is performed by deactivating the respective one power path and activating the respective other power path via the disconnecting elements or friction clutches.

In this first embodiment of the basic gear set, a direct gear is possible, which can be shifted by a direct connection between the drive and the output, while substantially leaving out the planetary gear sets and therefore with minimized drag losses. For this purpose, the planetary gear sets are arranged on higher shaft levels, i.e., on shaft levels which are located coaxially above a shaft level or longitudinal center axis of the basic gear set, which is defined by the driveshaft, the first transmission input shaft, the main shaft, and the output shaft. For the production of the direct connection of the first transmission input shaft to the main shaft and to the output shaft, which is fixedly connected in this first embodiment to the main shaft, only the fourth shift element is required. It is also only required for producing this direct connection in this embodiment.

The planetary gear sets can be designed as simple negative transmissions, i.e., as an epicyclic transmission having a negative stationary transmission ratio, wherein the stationary transmission ratio is given by the transmission ratio of two planetary set elements with a fixed planet carrier and the number of teeth of ring gears or gearwheels having internal gear teeth receives a negative sign according to the common standard. The two rotating elements, i.e., ring gear and sun gear, have opposing rotational directions in this case. Fundamentally, positive planetary gear sets are also possible for the vehicle transmission, wherein then the planet carrier and ring gear attachments are to be exchanged, since ring gear and sun gear have the same rotational directions in this case because of double rows of planetary gears. The stationary transmission ratio then increases by an absolute value of 1 in relation to a corresponding negative transmission.

To further simplify the basic gear set of the vehicle transmission, it can be provided that three planetary gear sets are arranged, which are shiftable via first, second, and third shift elements, each having two shift settings and a fourth shift element having one shift setting. In the first planetary gear set, the ring gear is additionally connected to the second transmission input shaft, the sun gear is permanently fixed on a rotationally-fixed component, and the planet carrier is alternately connectable to the ring gear or the planet carrier of the second planetary gear set via the second shift element and can be coupled via the fourth shift element to the first transmission input shaft. In the second planetary gear set, the ring gear is connectable via the first shift element to the first transmission input shaft, the sun gear is permanently fixed on a rotationally-fixed component, and the planet carrier is connectable via the third shift element to the planet carrier of the third planetary gear set. In the third planetary gear set, the ring gear is permanently fixed on a rotationally-fixed component, the sun gear is connectable via the third shift element to the planet carrier of the second planetary gear set and via the first shift element to the first transmission input shaft, and the planet carrier is connected to the output shaft. By means of this basic gear set of the vehicle transmission, at least eight forward gears are implementable, which are power-shiftable sequentially via the first and second disconnecting element, wherein the eighth gear is shiftable as a direct gear, which is shiftable by a coupling of the two partial transmissions via the second, third, and fourth shift elements.

Accordingly, with this basic gear set a direct gear is created by a coupling of both partial transmissions rather than by a direct connection of the drive and driven sides. A shaft plane can thus be dispensed with in the zone of the main shaft between the second and third planet gear set. In particular this can be effected if for shifting the direct gear, the elements of all three planet gear sets driven by the applied torque are shifted in sequence, wherein on the drive side the first driven element and the corresponding separator element can be coupled with the drive via the associated transmission input shaft, and the third driven element is coupled with the driven shaft of the transmission on the drive side such that, although the planet gear sets are coupled with one another, their translations to the driven side are not effective. The actual coupling of the partial transmissions is effected via the fourth shifting element. In addition, the second and third shifting elements must be shifted in order to achieve the direct gear.

Furthermore, provision can be made for the arrangement of another shifting element with at least one shifting position, via which the ring gear in the third planet gear set can be disengageably locked to a rotationally fixed component or coupled with the planet carrier.

Accordingly, in the basic gear set the connection of the ring gear of the third planet gear set by an additional shifting element can be configured as a disengageable coupling. The ring gear is locked in the respective gears in which the translation of the third planet gear set is not required. In the respective gears in which the translation of the third planet gear set is not required, when the ring gear is disengaged the third planet gear set can be shifted to a direct drive rather than allowing the planet gears and/or the sun gear to rotate freely. Unnecessary bearing losses and drag losses from freely rotating gears in the respective gears (speeds) can thus be avoided. The direct drive is achievable by the additional shifting element having, in addition to the shifting position for locking the ring gear, a second shifting position for coupling two elements of this planet gear set, for example the ring gear with the planet carrier. In this shifting position, the additional shifting element ensures the torque ratios defined by the direct drive on the planet gear set, without itself being load-carrying.

With the ring gear disengaged, in principle the direct drive can be effected via suitable combinations of shifting positions of other shifting elements that are present anyway and the aforementioned second shifting position can be dispensed with, provided that doing so still allows a possible shift pattern of the transmission and is also useful.

In the first two planet gear sets, in each case the fixed element (i.e., the sun gear in particular) can furthermore be configured such that it can be disengageably connected to the fixed component or rather to the transmission case by an additional shifting element and enable a direct drive of the associated components of both first planet gear trains in order to reduce bearing losses.

To save additional installation space and weight, neighboring shifting elements that are never simultaneously engaged in the possible or at least in the preferred shift patterns can be combined as shifting packages into shifting elements with several shifting positions, which are alternatingly actuated by means of a single actuator. In a manner known per se, double-sided or rather double-acting shifting elements, each with two shifting positions and an interposed neutral position, are already frequently used in various transmissions. The transmission structure of the invention furthermore enables the use of triple shifting elements.

Accordingly, provision can be made such that, particularly in the described second embodiment of the basic gear set, the first and fourth shifting elements, for example, are combined into a shifting element with three shifting positions. This is possible because the fourth shifting element is needed for the partial transmission coupling only in the highest gear. This gives rise to an additional installation space savings and weight benefit.

An additional installation space savings is achievable if the second planet gear set is arranged radially over the third planet gear set, wherein both of these planet gear sets are axially nested within one another. It is thus possible to dispense with a gear plane and shorten the transmission structure axially.

Further provision can be made such that the second separator element is configured as a brake, by means of which the sun gear of the first planet gear set can be locked to or disengaged from a rotationally fixed component.

Accordingly, use can be made of a brake rather than a second friction clutch. This is possible because the first planet gear set acts as an input constant of the second partial transmission. Accordingly, in each case the brake, rather than a second clutch, is engaged in order to activate the gears of the second partial transmission, whereas, for activating the gears of the first partial transmission, in each case the first clutch is engaged and the brake is released for the load-free preselection of the respective next gear. The brake thus assumes the function of the second separator element. The shift pattern of the transmission can be the same in both embodiments, i.e., with two friction clutches or with a friction clutch and brake.

In order to achieve at least one reverse gear in the vehicle transmission in the case of a purely engine-powered driving mode, another simple planet gear set can be arranged, which acts as a reversal gear set for switching the rotation direction between drive and output. The reversal gear set can be integrated at one of various places in the transmission structure.

According to another preferred embodiment of the invention, to this effect provision can be made for the arrangement of a fourth planet gear set configured as a reversal gear set and of a fifth shifting element with two shifting positions upstream of the first planet gear set for achieving as many as four reverse gears, wherein the ring gear of the reversal gear set is coupled with the ring gear of the first planet gear set, wherein the sun gear of the reversal gear set is coupled with the second transmission input shaft and is capable of being coupled with the planet carrier of the reversal gear set via the fifth shifting element, and wherein the planet carrier of the reversal gear set can be locked to a rotationally fixed component via the fifth shifting element.

This arrangement permits four reverse gears, which can have very short gear ratios. For example, the lowest reverse gear can have approximately twice the translation of the lowest forward gear. Accordingly, in particular it is possible to achieve a first reverse gear that generates a very low drive speed in the idle mode of a drive unit configured as an internal combustion engine such that comfortable, sensitive reverse maneuvering is possible with the friction clutch fully engaged and without actuating the brake pedal. Owing to the short translation of the drive torque, especially of the first gear, setting a torque limit of the internal combustion engine is useful in order to limit the strain on the transmission.

The reversal gear set is coupled to the first planet gear set, in other words to the second partial transmission. All four possible reverse gears can thus be shifted via the second separator clutch. The fifth shifting element serves for shifting to and from the reverse gear translations and the forward gear translations.

In another preferred embodiment of the invention, provision can be made for the arrangement of a fourth planet gear set configured as a reversal gear set and of a fifth shifting element with two shifting positions upstream of the first planet gear set for achieving as many as four reverse gears, wherein the ring gear of the reversal gear set is coupled with the planet carrier of the first planet gear set, wherein the sun gear of the reversal gear set can be coupled with the second transmission input shaft via the fifth shifting element, and wherein the planet carrier of the reversal gear set is permanently locked to a rotationally fixed component.

In another embodiment, provision can be made for the arrangement of a fourth planet gear set configured as a reversal gear set and of a fifth shifting element with two shifting positions upstream of the first planet gear set for achieving up to four reverse gears, wherein the ring gear of the reversal gear set is coupled with the planet carrier of the first planet gear set, wherein the sun gear of the reversal gear set can be coupled with the second transmission input shaft via the fifth shifting element, and wherein the planet carrier of the reversal gear set is permanently locked to a rotationally fixed component and also coupled with the sun gear of the first planet gear set.

The two aforementioned arrangements enable four reverse gears whose translations are only negligibly shorter than the corresponding forward gears. Hence setting a torque limit on the internal combustion engine in the reverse driving mode is not required here.

The same reverse gear translations as in the two aforementioned arrangements enable two other preferred embodiments of the invention in which, however, a shorter overall axial length arises.

This can be achieved in that for achieving up to four reverse gears, a fourth planet gear set configured as a reversal gear set is disposed upstream of the first planet gear set and a fifth shifting element with two shifting positions is present, which is arranged radially over the reversal gear set and/or over the first planet gear set, wherein the ring gear of the reversal gear set is coupled with the planet carrier of the first planet gear set, wherein the sun gear of the reversal gear set is coupled with the second transmission input shaft, and wherein the planet carrier of the reversal gear set can be locked to a rotationally fixed component via the fifth shifting element.

This is furthermore achievable in that a fourth planet gear set configured as a reversal gear set and a fifth shifting element with two shifting positions are arranged for achieving up to four reverse gears, wherein the reversal gear set is arranged radially over and nested within the first planet gear set, wherein the ring gear of the reversal gear set is coupled with the planet carrier of the first planet gear set, wherein the sun gear of the reversal gear set is coupled with the second transmission input shaft, and wherein the planet carrier of the reversal gear set can be locked to a rotationally fixed component via the fifth shifting element.

In another embodiment, for achieving one or two reverse gears, provision is made for a fourth planet gear set, which is configured as a reversal gear set and is arranged between the second and the third planet gear set, wherein the second and fifth shifting elements are combined into a common shifting element with three shifting positions, wherein the ring gear of the reversal gear set is coupled with the planet gear carrier of the second planet gear set, wherein the sun gear of the reversal gear set can be coupled with the planet carrier of the first planet gear set via the fifth shifting element, and wherein the planet carrier of the reversal gear set is permanently locked to a rotationally fixed component.

Although the aforementioned transmission arrangement enables just two reverse gears, a separate fifth shifting element can be dispensed with since the function of shifting from the forward gears to the reverse gears can be integrated as a third shifting position in the existing second shifting element, thus reducing the cost and construction effort. In this transmission arrangement, it is furthermore possible to combine the first and fourth shifting elements into a common shifting element with three shifting positions.

The transmission structure of the invention with two partial transmissions or rather with two power paths via two transmission input shafts also permits an expedient use of the same in a hybrid drive train of a motor vehicle.

In another embodiment of the invention, the vehicle transmission can accordingly be configured as a so-called hybrid transmission, wherein the second transmission input shaft is operatively connected to the rotor of an electric machine, and wherein the second separator element is configured as an interlocking clutch by means of which the second transmission input shaft can be coupled with the first transmission input shaft.

Accordingly, the second transmission input shaft is drive-coupled with the rotor of an electric machine in this alternative embodiment. The electric machine then enables a purely electric motor-driven driving mode via the second partial transmission. Rather than a second friction clutch, only an interlocking clutch is required to enable a combined electric motor-internal combustion engine driven driving mode via the second partial transmission, which interlocking clutch can couple the second transmission input shaft with the first transmission input shaft and thus with the drive shaft as well as the internal combustion engine. The driving mode in the first partial transmission, on the other hand, is preferably purely internal combustion engine-driven, in other words with the coupling between the two transmission input shafts disengaged.

A possible shift pattern of the hybrid transmission with a power shifting sequence can correspond to a shift pattern of a transmission according to the embodiments with two friction clutches or with a friction clutch and a brake.

In the hybrid drive train, the possibility of reversing the rotation direction of the electric machine enables the achievement of reverse gears without an additional reversal gear set, wherein in particular the translation of the lowest forward gear can be used in an expedient manner for the reverse driving mode.

The shiftable coupling of the transmission input shafts with one another also enables typical hybrid functions such as boosting (i.e., torque increase) and starting the internal combustion engine by means of the electric machine.

The embodiments of the invention described thus far enable up to eight power-shiftable forward gears (including a direct gear) with three planet gear sets and up to four reverse gears with an additional reversal gear set, or alternatively an electric motor-driven reverse drive function without an additional reversal gear set if use is made of an electric machine.

Furthermore, the vehicle transmission with the features of the invention can be upgraded by means of an extension to an auxiliary transmission, whereby the number of gears can be easily doubled, in particular for applications in utility vehicles.

According to another embodiment of the invention, provision can be made such that the vehicle transmission is configured as a double clutch auxiliary transmission, wherein downstream of the third planet gear set is arranged a range group comprising a fourth planet gear set configured as a reversal gear set, to which is allocated a fifth shifting element with a shifting position for shifting a reverse gear group, further comprising a fifth planet gear set to which is allocated a sixth shifting element with two shifting positions for shifting to and from a slow and a fast forward gear group. With this construction a total of up to sixteen forward gears (of which at least fifteen are power-shiftable) and up to eight reverse gears (all power-shiftable) are made available, wherein in the fourth planet gear set, whose ring gear is coupled with the sun gear of the fifth planet gear set, the sun gear of said fourth planet gear set is coupled with the planet carrier of the third planet gear set and the planet carrier of the fourth planet gear set is coupled with the ring gear of the fifth planet gear set and can be locked to a rotationally fixed component via the fifth shifting element, and wherein in the fifth planet gear set, whose sun gear can be alternatingly locked to a rotationally fixed component or coupled with the planet carrier of said fifth planet gear set via the sixth shifting element, and the planet carrier of the fifth planet gear set is coupled with the drive shaft.

Accordingly, with this arrangement the number of gears of an eight-gear main transmission having the features of the invention can be doubled by means of an attached range group. The range group can be shifted by interrupting the tractive power without any additional measures. However, the tractive power interruption can be minimized by designing the range selector with a lower gear step compared to the other gears, and thus with a rather low speed loss. All other gears, including the up to eight reverse gears, are power shiftable.

### BRIEF DESCRIPTION OF THE DRAWINGS

For further clarification of the invention, a drawing with exemplary embodiments is appended to the description. Shown are:

FIG. 1 a transmission diagram of a first embodiment of a vehicle transmission of the invention, with a double clutch and three planet gear sets as well as with a shiftable direct translation via a direct connection between the drive and driven sides,

FIG. 2 a transmission ratio diagram of planet gear sets for a vehicle transmission according to FIG. 1,

FIG. 3 a shift pattern for a vehicle transmission according to FIG. 1, with a direct gear,

FIG. 4 a transmission scheme of a second embodiment of a vehicle transmission of the invention, with a direct translation shiftable via a partial transmission coupling,

FIG. 5 a shift pattern for a vehicle transmission according to FIG. 4,

FIG. 6 a transmission diagram of a third embodiment of a vehicle transmission of the invention, with a triple shifting element,

FIG. 7 a transmission diagram of a fourth embodiment of a vehicle transmission of the invention, with nested planetary gear sets,

FIG. 8 a transmission diagram of a fifth embodiment of a vehicle transmission of the invention, with a clutch and a brake,

FIG. 9 a shift pattern for a vehicle transmission according to FIG. 8,

FIG. 10 a transmission diagram of a sixth embodiment of a vehicle transmission of the invention, with an electric machine,

FIG. 11 a shift pattern for a vehicle transmission according to FIG. 10,

FIG. 12 a transmission diagram of a seventh embodiment of a vehicle transmission of the invention, with a first arrangement of a reverse planet gear set,

FIG. 13 a transmission ratio diagram of planet gear sets for a vehicle transmission according to FIG. 12,

FIG. 14 a shift pattern for a vehicle transmission according to FIG. 12,

FIG. 15 a transmission diagram of an eighth embodiment of a vehicle transmission of the invention, with a second arrangement of a reverse planet gear set,

FIG. 16 a transmission ratio diagram of planet gear sets for a vehicle transmission according to FIG. 15,

FIG. 17 a shift pattern for a vehicle transmission according to FIG. 15,

FIG. 18 a transmission diagram of a ninth embodiment of a vehicle transmission of the invention, with a third arrangement of a reverse planet gear set,

FIG. 19 a transmission diagram of a tenth embodiment of a vehicle transmission of the invention, with a fourth arrangement of a reverse planet gear set,

FIG. 20 a transmission diagram of an eleventh embodiment of a vehicle transmission of the invention, with a fifth arrangement of a reverse planet gear set,

FIG. 21 a transmission diagram of a twelfth embodiment of a vehicle transmission of the invention, with a sixth arrangement of a reverse planet gear set,

FIG. 22 a transmission ratio diagram of planet gear sets for a vehicle transmission according to FIG. 21,

FIG. 23 a shift pattern for a vehicle transmission according to FIG. 21,

FIG. 24 a transmission diagram of a thirteenth embodiment of a vehicle transmission of the invention, with an additional shifting element,

FIG. 25 a shift pattern for a vehicle transmission according to FIG. 24,

FIG. 26 a transmission diagram of a fourteenth embodiment of a vehicle transmission of the invention, with a range group,

FIG. 27 a transmission ratio diagram of planet gear sets for a vehicle transmission according to FIG. 25, and

FIG. 28 a shift pattern for a vehicle transmission according to FIG. 25.

### DETAILED DESCRIPTION OF THE PREFERRED EMBODIMENTS

As a preliminary remark it should be noted that, for simplification, functionally identical components are marked with the same reference numerals in the figures.

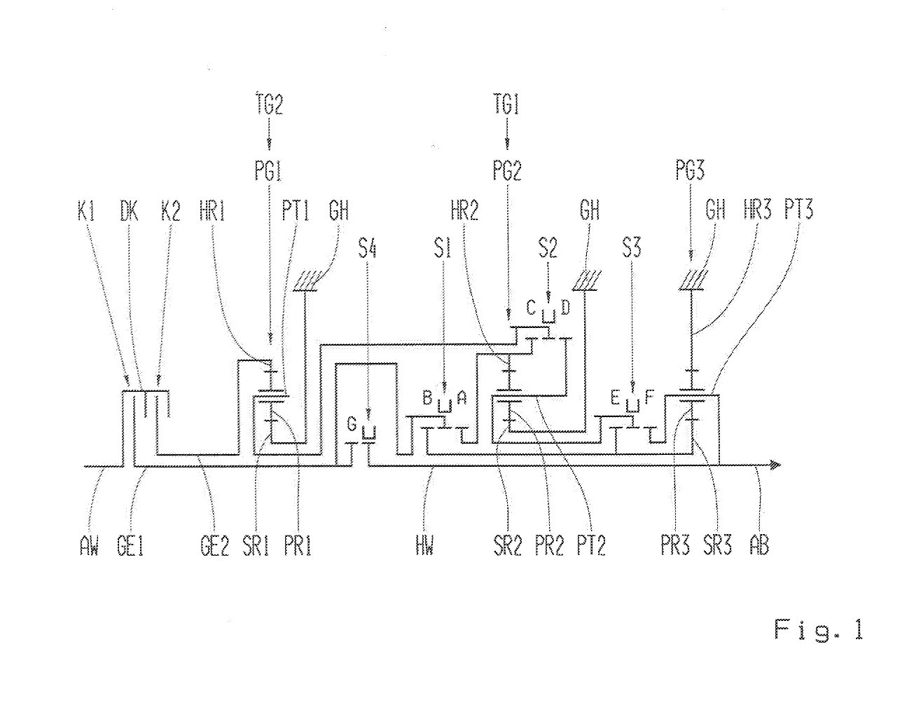

Accordingly, a vehicle transmission schematically illustrated in FIG. 1 essentially shows three planetary gear sets PG1, PG2, PG3, one drive shaft AW, two transmission input shafts GE1, GE2, a main shaft HW and an output shaft AB, coaxially arranged to one another.

The planetary gear sets PG1, PG2, PG3 are designed as simple minus gear sets, each comprising a radially outer ring gear HR1, HR2, HR3, an inner sun gear SR1, SR2, SR3 and a planetary carrier PT1, PT2, PT3, wherein the planetary carrier PT1, PT2, PT3 features a plurality of planetary wheels PR1, PR2, PR3 that mesh with the sun gear SR1, SR2, SR3 and the ring gear HR1, HR2, HR3.

The vehicle transmission according to FIG. 1 features a double clutch DK with two friction clutches K1, K2, the input sides of which are formed by a common clutch basket that is drive-connected to the drive shaft AW of a drive unit that is not shown, for example a drive unit designed as an internal combustion engine. The output sides of the double clutch DK are each connected to one of two coaxially arranged transmission input shafts GE1, GE2. The first transmission input shaft GE1 is connected to the first clutch K1, and is configured as a radially inner solid circular shaft, which emerges from the second transmission input shaft GE2 on the transmission side and which is connected to the second clutch K2 and is designed as an outer hollow shaft.

The above-mentioned main shaft HW is positioned coaxially to the two transmission input shafts GE1, GE2 and axially adjacent to the first transmission input shaft GE1. The output end of the main shaft HW is firmly connected to the output shaft AB.

The three planetary gear sets PG1, PG2, PG3 are shiftable by means of a first, a second and a third shifting component S1, S2, S3. These three shifting components S1, S2, S3 each have two shifting positions A/B, C/D, E/F, which are alternately shiftable. A fourth shifting component S4 also exists, which has only one shifting position G. All stated shifting components S1, S2, S3, S4 also have a neutral position.

The first clutch K1 and the transmission input shaft GE1 together with the second planetary gear set PG2 form a first sub-transmission TG1. For this purpose, the first transmission input shaft GE1 can be connected via the first shifting component S1 in its first shifting position A to the ring gear HR2 of the second planetary gear set PG2. In the second shifting position B of the first shifting component S1, the first transmission input shaft GE1 is connectable to the sun gear SR3 of the third planetary gear set PG3.

In addition, the sun gear SR2 of the second planetary gear set PG2 is permanently fixed on a non-rotating component GH (transmission casing) and the planetary carrier PT2 of this second planetary gear set PG2 via the third shifting component S3 in the second shifting position F is connectable to the planetary carrier PT3 of the third planetary gear set PG3.

In addition, the first transmission input shaft GE1, via the fourth shifting component S4 in its shifting position G, is connected directly to the main shaft HW and thus to the output shaft AB.

The second clutch K2 and the transmission input shaft GE2, together with the first planetary gear set PG1, form a second sub-transmission TG2. For this purpose, the sec-ond transmission input shaft GE1 is connected to the ring gear HR1 of the first planetary gear set PG1. The sun gear SR1 of the first planetary gear set PG1 is permanently fixed to a non-rotating component GH and the planetary carrier PT1 of the first planetary gear PG1 is connectable via the second shifting component S2 alternately in its first shifting position C to the ring gear HR2 of the second planetary gear set PG2 or in its second shifting position D to the planetary carrier PT2 of the second planetary gear set PG2.

In the third planetary gear set PG3, the ring gear HR3 is permanently fixed to a non-rotating component GH, its sun gear SR3 is connectable via the third shifting component S3 in its first shifting position E to the planetary carrier PT2 of the second planetary gear set PG2, and the planetary carrier PT3 of the third planetary gear set PG3 is connected in a non-rotating manner to the output shaft AB.

FIG. 2 shows a numerical example of a possible gear ratio of the three planetary gear sets PG1, PG2, PG3, where, in addition to the respective stationary gear ratio i0 with a fixed planetary carrier, the planetary gear set gear ratio i_PG is indicated in the transmission structure according to FIG. 1.

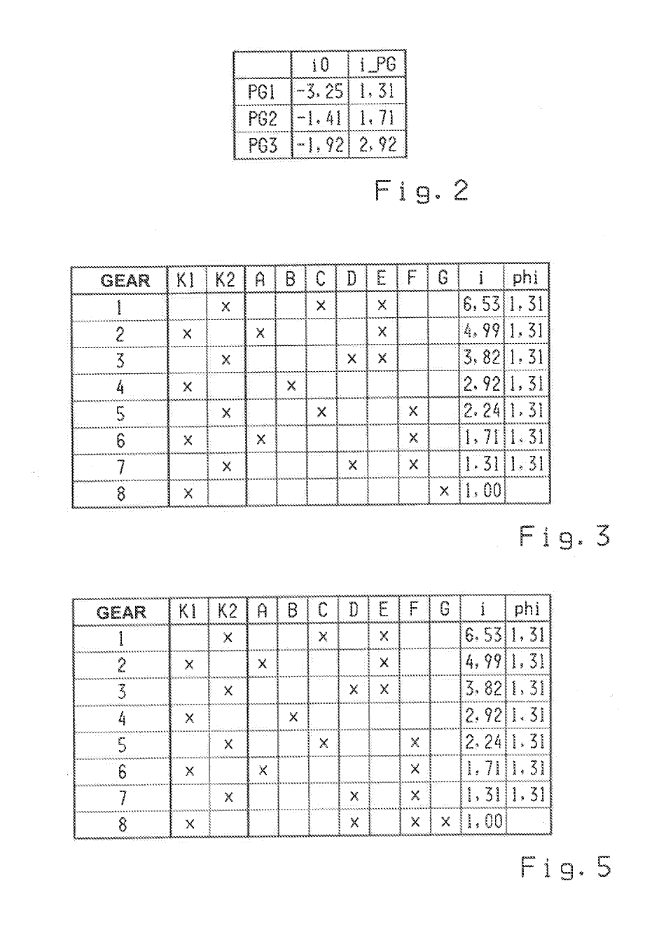

A possible shift pattern of the transmission configuration according to FIG. 1 is shown in FIG. 3. Those shifting positions of the transmission that are activated for setting a gear are marked with an “x” in the shift pattern. Accordingly, eight forward gears “1” through “8” are shiftable in the transmission. The gears are activated in the operating sequence in a sequential change via the two clutches K1, K2, wherein an overlapping disengaging and engaging of the clutches K1, K2 sustains traction force while changing between the two sub-transmissions TG1, TG2.

For example, the gear change takes place between the first gear “1” and the second gear “2” as follows:

In first gear “1” the second clutch K2 is engaged. The second sub-transmission TG2 is therefore under load. In the process, the second shifting component S2 is in the shifting position C where, on the drive side, the ring gear HR2 of the second planetary gear set PG2 is connected to the planetary carrier PT1 the first planetary gear set PG1. The third shifting component S3 is in the shifting position E, where, on the output side, the planetary carrier PT2 of the second planetary gear set PG2 is connected to the sun gear SR3 of the third planetary gear PG3, so that the gear ratio of the third planetary gear set PG3 acts on the output shaft.

In second gear “2”, the shifting position E of the third shifting component S3 remains in place. In addition, the first shifting component S1 is moved to the shifting position A, in which the ring gear HR2 of the second planetary gear set PG2 is connected to the first transmission input shaft GE1. This is possible because the first clutch K1 is still disengaged from the active first gear “1” and thus the first sub-transmission TG1 is still inactive.

To execute the gear change from the first gear “1” to the second gear “2”, the second clutch K2 is now disengaged and the first clutch K2 is engaged, wherein the frictional lock is reduced at the one clutch K2 and synchronized accordingly at the other clutch K2, so that ultimately the load transfer from the second sub-transmission TG2 to the first sub-transmission TG1 occurs without loss of traction force in the drive train. The second shifting component S2 can then be disengaged without load.

In the shift pattern according to FIG. 3, the gear ratio is stated for each gear “1” through “8”. The eight gears “1” through “8” feature a constant gear step phi, mean-ing a geometric step range. The eighth gear “8” is designed as a direct gear, which can be activated by engaging the fourth shifting component S4. In the relevant shifting position G of the fourth shifting component S4 and with the clutch K1 engaged, the drive unit is directly drive-connected to the output shaft AB, as shown in FIG. 1.

In the transmission structure according to FIG. 1, a reverse gear is not included for clarification of the basic structure of the transmission. The transmission structure shown there thus forms a basic gear set which can be expanded by a reversal gear set to realize at least one reverse gear.

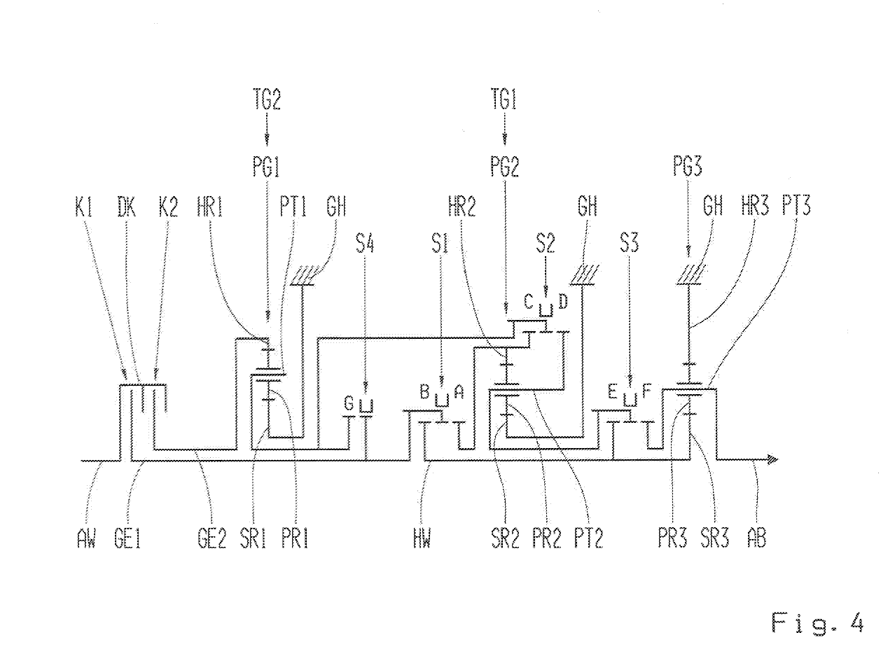

FIG. 4 shows a modified basic gear set in comparison to FIG. 1, wherein the output end of the main shaft HW is not directly connected to the output shaft AB but to the sun gear SR3 of the third planetary gear set. A direct connection between the first transmission input shaft GE1 and the main shaft HW can also not be created via the fourth shifting component S4, but a connection between the first transmission input shaft GE1 and the planetary carrier PT1 of the first planetary gear set PG1. This eliminates one shaft level between the main shaft level and the planetary carrier shaft level of the second planetary gear set PG2. For the rest, the transmission structure corresponds to the basic gear set according to FIG. 1.

An associated shift pattern is shown in FIG. 5. The direct gear “8” in this transmission structure is realized by coupling the two sub-transmissions TG1, TG2 via the fourth shifting component S4 in the shifting position G and by connecting the planetary carriers PT2, PT3 of the second and third planetary gear set PG2, PG3 to the output shaft AB (shift positions D and F). When shifting from seventh gear “7” to the eighth gear “8”, the direct gear, the shift positions D and F of the second or respectively third shifting component S2, S3 of the second and third planetary gear sets PG2, PG3 remain in place. For the rest, the shift pattern corresponds to the shift pattern according to FIG. 3 of the basic gear set according to FIG. 1

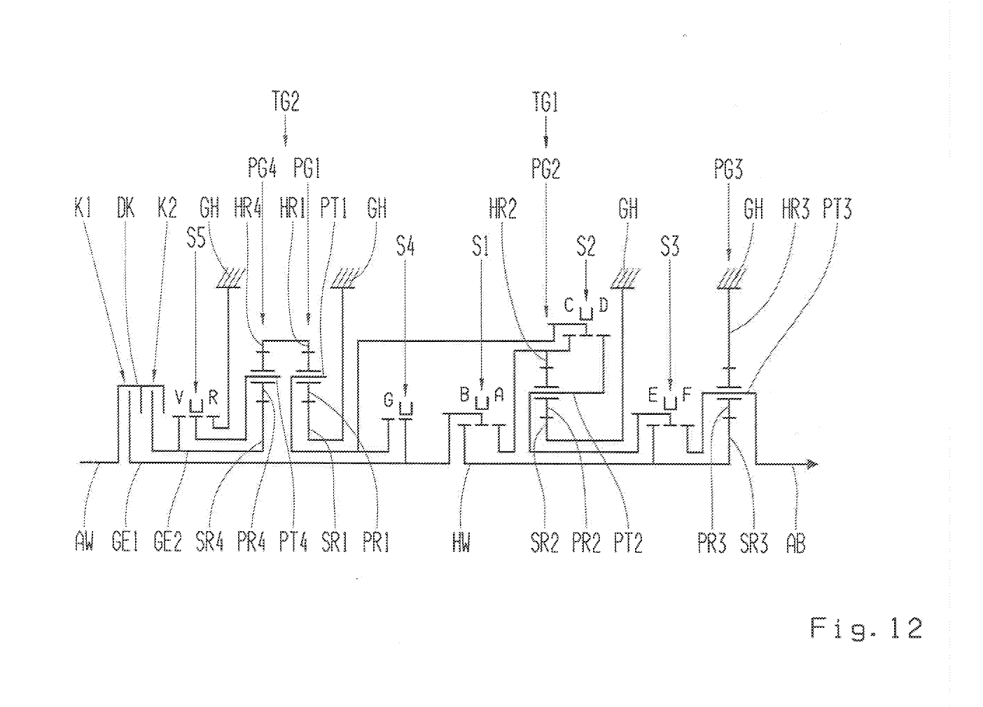

The transmission structure according to FIG. 4 is also expandable by a reversal gear set in order to realize at least one reverse gear. Various reverse gear options are explained in FIG. 12 to FIG. 23.

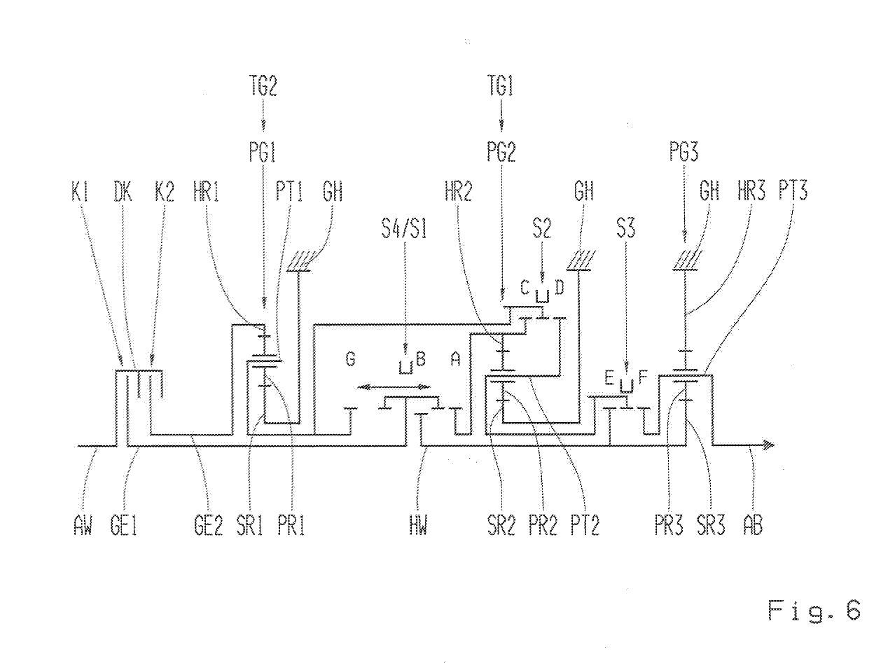

FIG. 6 shows a configuration that is largely identical to the transmission structure according to FIG. 4, however, the first and fourth shifting components S1, S4 are combined in a triple shifting component S4/S1 with a total of three shifting positions A, B, G. The three shifting positions A, B, G can alternately be actuated with a common actuator (not shown). As shown in the shift pattern according to FIG. 5, these shifting positions A, B, G are never engaged at the same time, since they are assigned to the same sub-transmission TG1. Therefore, this triple shifting component S1/S4 can be used with its three shift positions A/B/G.

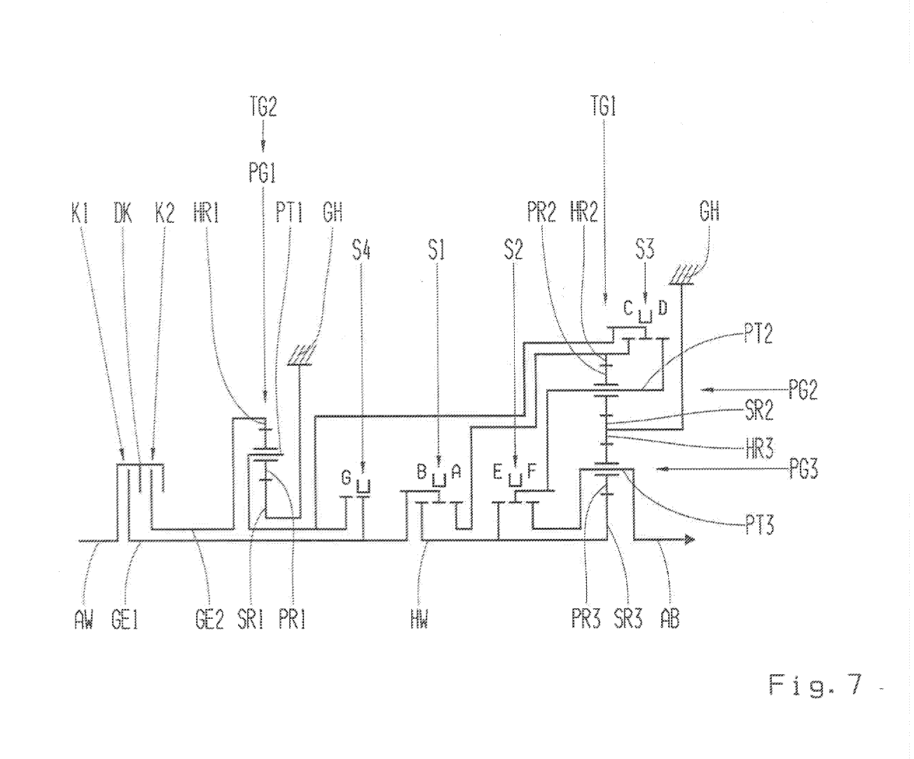

FIG. 7 shows a further variant of the basic gear set according to FIG. 4, wherein the second and third planetary gear sets PG2, PG3 are arranged in a common gear set level radially one above the other. The connection of the individual gear set ele-ments and the shift pattern correspond to the transmission structure according to FIG. 4 or the shift pattern according to FIG. 5.

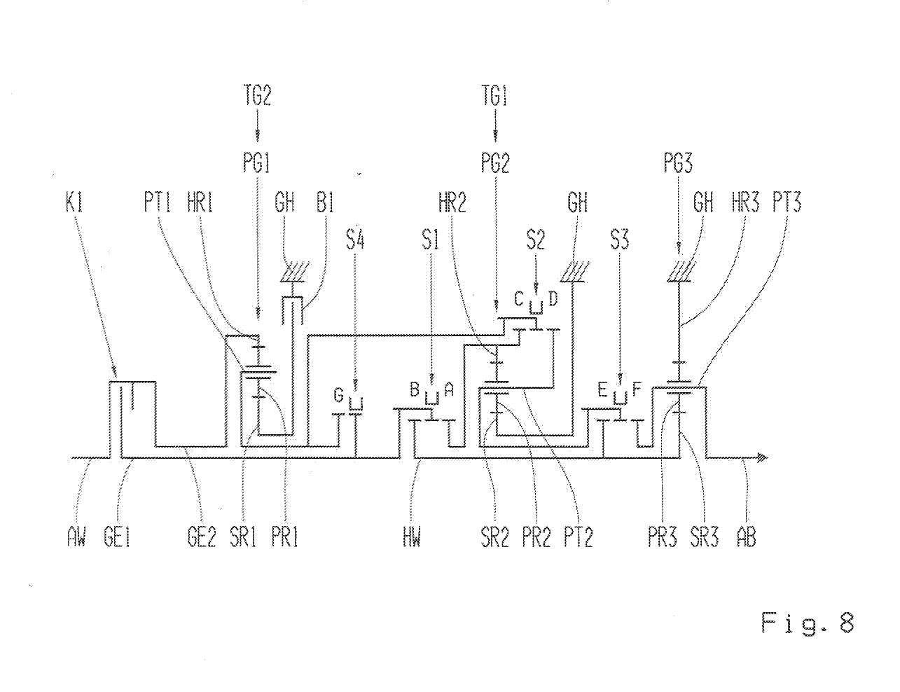

FIG. 8 shows a transmission structure in which a brake B1 is arranged instead of the second friction clutch K2. This is possible since the first planetary gear set PG1 acts as an input constant of the second sub-transmission TG2. Because of the brake B1, the sun gear SR1 of the first planetary gear set PG1 can be brake-locked to the non-rotating component GH and can also be released again from it. The second transmission input shaft GE2 is connected to form a drive system on the transmission side directly to the drive unit and on the transmission side to the ring gear HR1 of the first planetary gear set PG1.

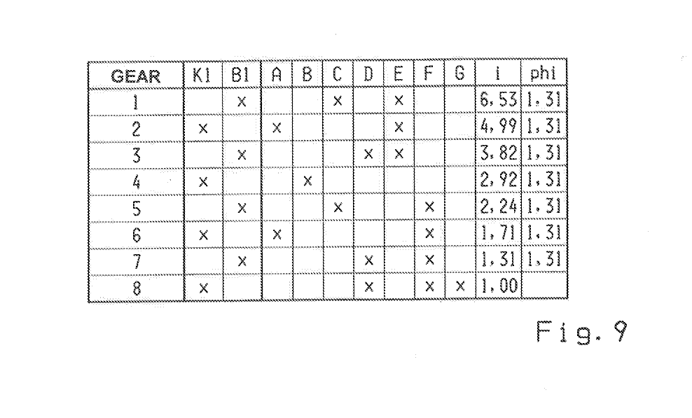

A shift pattern illustrated in FIG. 9 for this transmission structure largely corresponds to the shift pattern according to FIG. 5, wherein instead of the second clutch K2, the brake B1 is actuated. The gear ratios of the eight forward gears “1” through “8” and the planetary gear sets PG1, PG2, PG3 are identical to the transmission pursuant to FIG. 4.

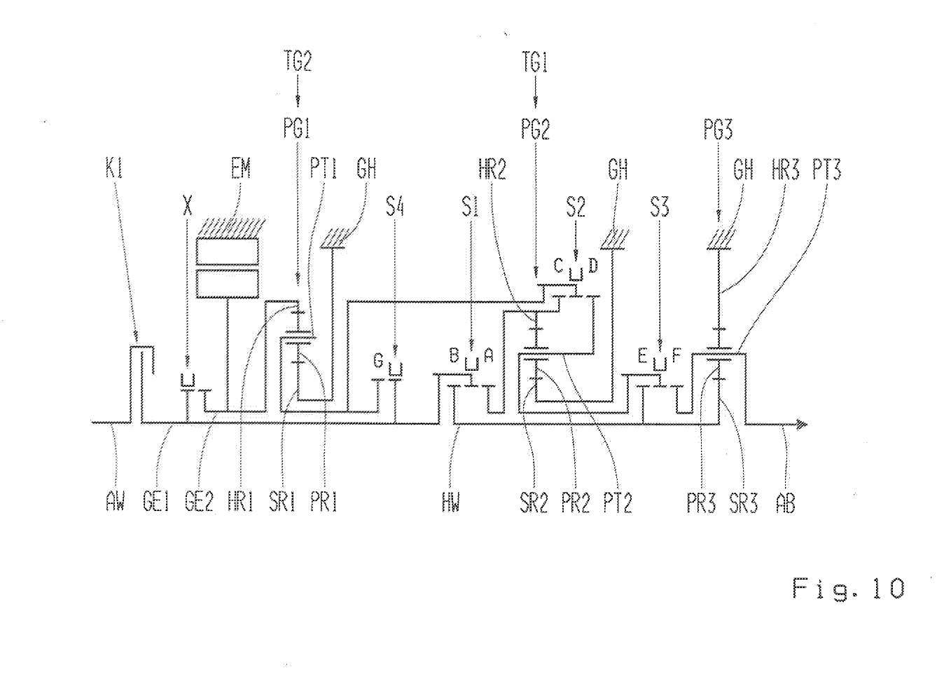

FIG. 10 shows an embodiment of a so-called hybrid transmission. In this transmission structure, instead of the second clutch K2, an electric motor EM or, respectively, its rotor is connected to the second transmission input shaft GE2. Furthermore, a separating clutch X is arranged, by means of which the second transmission input shaft GE2 can be connected directly to the first transmission input shaft GE1 and in-directly to the drive shaft AW, in order to allow a combined internal combustion en-gine/electric motor drive mode. For the rest, the transmission structure corresponds to the transmission according to FIG. 4

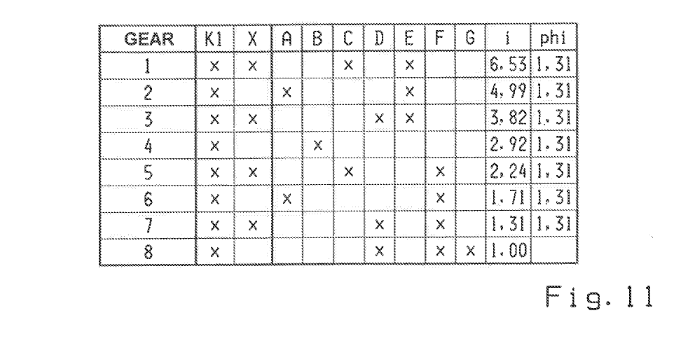

An associated, possible shift pattern is shown in FIG. 11. It demonstrates that in the odd gears “1”, “3”, “5”, “7”, which are assigned to the second sub-transmission TG2, the drive is effected with an engaged separating clutch K1, X from the electric motor EM and the internal combustion engine. The friction clutch K1 may remain engaged in all gears. Generally, however, a purely electric motor drive mode is possible in the odd gears “1”, “3”, “5”, “7” with a disengaged friction clutch K1 and engaged separating clutch K1 X. In the even gears “2”, “4”, “6”, “8”, which are assigned to the first sub-transmission TG1, the drive is effected only via the internal combustion engine or via the engaged friction clutch K1. When shifting from seventh gear “7” to the eighth gear “8”, the direct gear, the shifting positions D, F of the second and third planetary gear sets PG2, PG3 remain in place. The direct gear “8”, however, can be driven by the internal combustion engine only because the separating clutch X must be opened due to the sub-transmission coupling in the direct gear “8”. While shifting gears, a load can be shifted via the electric motor-driven gears as supporting gears.

FIGS. 12 to 23 show different embodiments for the installation of a reverse gear set in the transmission structure according to FIG. 4 to realize reverse gears.

According to FIG. 12, a fourth planetary gear set PG4 acts as a reverse gear set. The fourth planetary gear set PG4 is upstream on the drive train of the first planetary gear set PG1 and is thus allocated to the second sub-transmission TG2. A fifth shift-ing component, having two shifting positions V, R for shifting between forward and reverse drive mode, is located on the second transmission input shaft GE2. The ring gear HR4 of reverse gear set PG4 is connected to the ring gear HR1 of the first planetary gear set PG1 and the sun gear SR4 of the reverse gear set PG4 is connected to the second transmission input shaft GE2. The planetary carrier PT4 of the reverse gear set PG4 is connectable via the fifth shifting component S5 alternately, in its first shifting position V to the second transmission input shaft GE2, or in its second shifting position R to the non-rotating component (transmission casing) GH.

By connecting the planetary carrier PT4 of the reverse gear set PG4 to the second transmission input shaft GE2, it is simultaneously connected to the sun gear SR4 of the reverse gear set PG4, so that, in forward drive mode, the reverse gear set PG4 is a direct drive. By fixing the planetary carrier PT4 of reverse gear set PG4 to the non-rotating component GH, the negative stationary gear ratio of the fourth planetary gear set PG4, embodied as negative gear, is active, so that the rotational direction between the sun gear SR4 and the ring gear HR4 of this reverse gear set PG4 reverses for reverse drive mode.

FIG. 13 shows a numerical example of a gear ratio table with the additional planetary gear set PG4, which shows that its effective gear ratio corresponds to the stationary gear ratio i0.

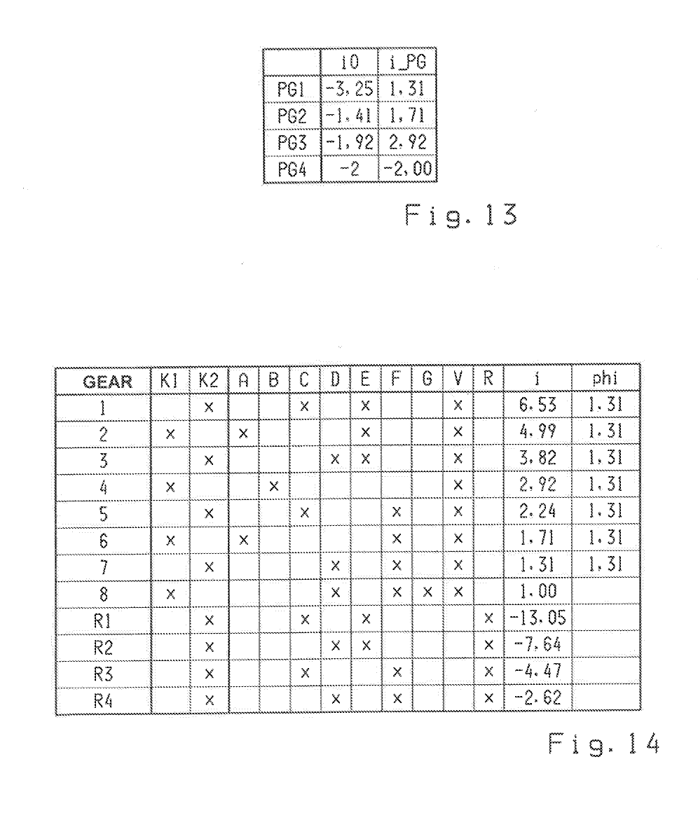

FIG. 14 shows a possible shift pattern of the transmission according to FIG. 12. For the eight forward gears “1” through “8”, this shift pattern corresponds to the shift pattern according to FIG. 5 for the transmission structure according to FIG. 4, wherein, additionally, the fifth shifting component S5 is in the forward gear position V. Four reverse gears R1, R2, R3, R4 are also shiftable, which are all shifted via the second clutch K2, wherein the fifth shifting component S5 is in the reverse gear shift position R. The numerical example according to FIG. 14 shows in particular that a lowest reverse gear R1 can be realized, which is about twice as high as the lowest forward gear “1”, i.e. with a very short gear ratio.

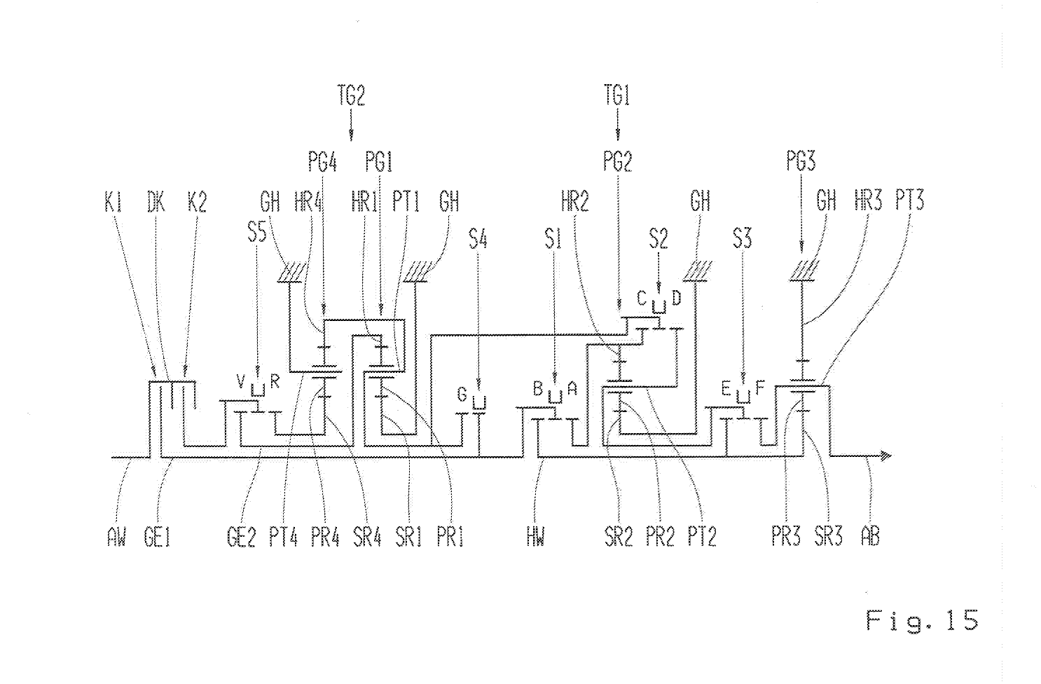

FIG. 15 shows a transmission structure with an alternative connection of a fourth planetary gear set PG4 arranged as reverse gear set. Here the ring gear HR4 is connected to the planetary carrier PT1 of the first planetary gear set PT1. The planetary carrier PT4 of the fourth planetary gear set PG4 is permanently fixed to the non-rotating component GH. The sun gear SR4 of the fourth planetary gear set PG4 is connectable to the second transmission input shaft GE2 for shifting the reverse drive mode via the fifth shifting component S5. The second transmission input shaft GE2 is also connectable to the ring gear HR1 of the first planetary gear set PG1 via the fifth shifting component S5 for shifting into forward drive mode, whereby the fourth planetary gear set PG4 also rotates without function.

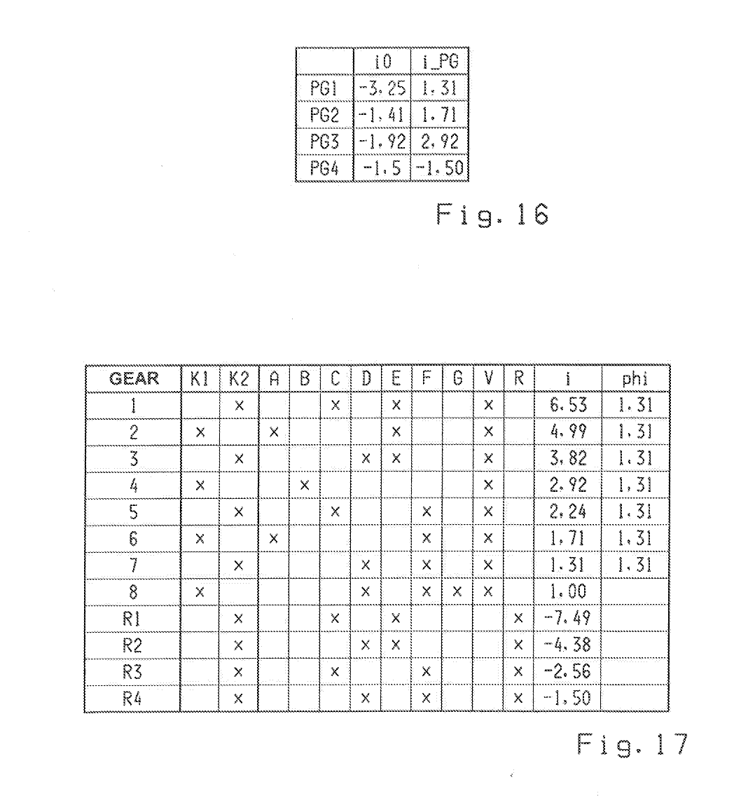

FIG. 16 shows a numerical example of a gear ratio table with the additional planetary gear set PG4 according to FIG. 15, wherein its effective stationary gear ratio i0 is lower than in the transmission structure according to FIG. 12.

FIG. 17 shows a possible shift pattern of the transmission according to FIG. 15, wherein it is evident that the four reverse gears R1 through R4 approximate the gear ratios of the corresponding forward gears first gear “1”, third gear “3”, fifth gear “5”, and seventh gear “7”.

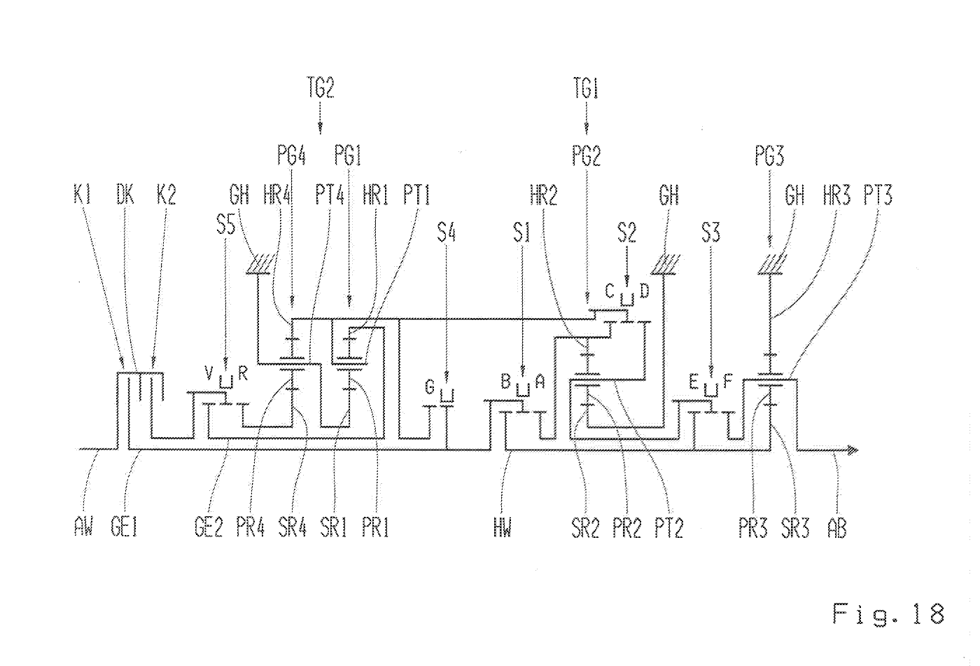

FIG. 18 shows a comparable transmission structure in which the gear ratios of the four planetary gear sets PG1, PG2, PG3, PG4 and the eight forward gears “1” through “8” and the four reverse gears R1 to R4 correspond to the configuration shown in FIG. 15 or, respectively, the schematic according to FIG. 16 and FIG. 17. How-ever, here the planetary carrier PT4 of reverse gear set PG4 is connected to the sun gear SR1 of the first planetary gear set PG1, whereby these two elements PT4, SR1 are jointly fixed to the non-rotating component GH. The interconnected ring gear HR4 of reverse gear set PG4 and planetary carrier PT1 of the first planetary gear PG1 are jointly connected to the second shifting component S2. This results in a functionality that according to FIG. 15 is comparable to the functionality of the transmission structure.

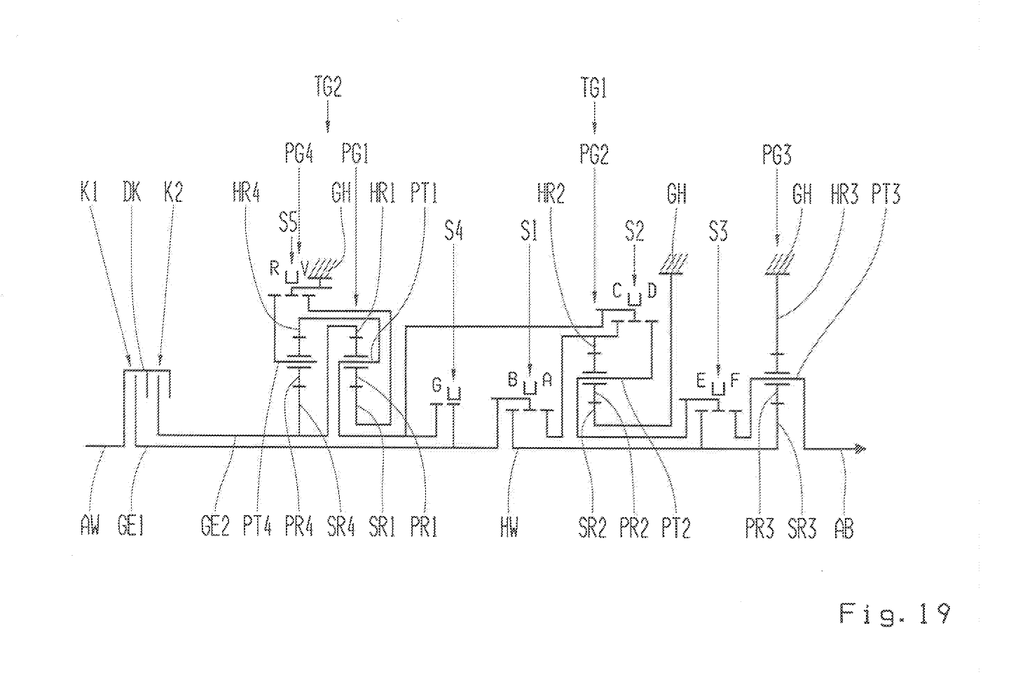

FIG. 19 shows another reverse gear variant. Here, the fifth shifting component S5 is located radially above the first and fourth planetary gear sets PG1, PG4. As with the transmission structures according to FIG. 15 and FIG. 18, the ring gear HR4 of the reverse gear set PG4 is connected to the planetary carrier PT1 the first planetary gear set PG1. The sun gear SR4 of reverse gear set PG4 is connected to the second transmission input shaft GE2 and the planetary carrier PT4 of the reverse gear set PG4 can be fixed to the non-rotating component GH via the fifth shifting component S5 for reverse drive mode. For the forward drive mode, the fifth shifting component S5, the sun gear SR1 of the first planetary gear set PG1 can be fixed to the non-rotating component GH. The shift pattern and the gear ratios are identical to the schematics pursuant FIGS. 16 and 17 of the transmission structures according to FIG. 15 and FIG. 18.

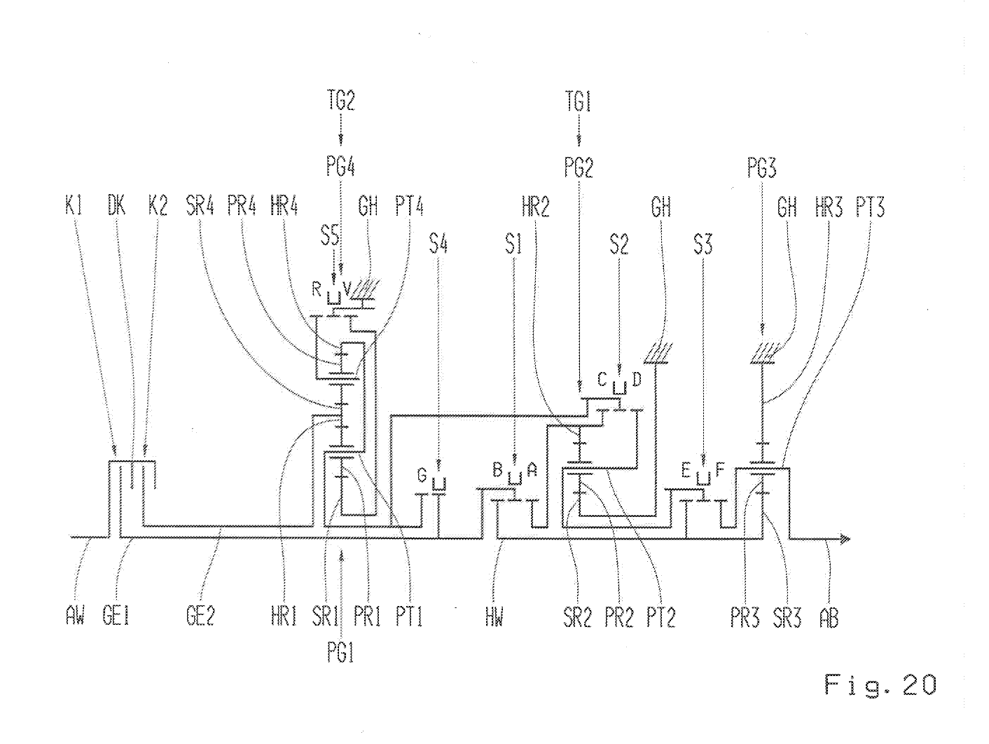

FIG. 20 shows another reverse gear variant using the same gear ratios and the same shift pattern. Here, the reverse gear set PG4 and the first planetary gear set PG1 are set radially one above the other, so that they form a common gear level. The connection of the gear set elements ring gear HR4, sun gear SR4, and planetary carrier PT4 of reverse gear set PG4 corresponds to the transmission structure pursu-ant to FIG. 19.

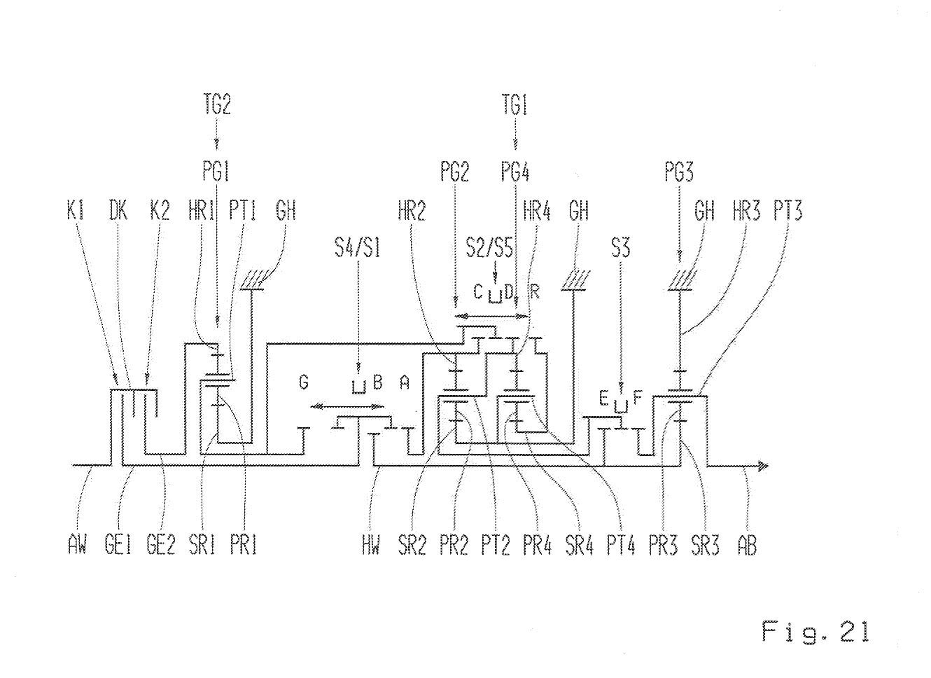

FIG. 21 shows a transmission structure in which a reverse gear set PG4 is located axially between the second and third planetary gear sets PG3 PG2. The fifth shifting component S5 in this case only requires a shift position R to activate the reverse drive function and, jointly with the second shifting component S2, is combined into a triple shifting component S2/S5. Furthermore, the first and fourth shifting components S1, S4 are combined to form a common shifting component S4/S1. The planetary carrier PT4 of the reverse gear set PG4 is fixed to the non-rotating component GH. The sun gear SR4 of reverse gear set PG4 is connectable to the planetary carrier PT1 of the first planetary gear set PG1 and the ring gear HR4 of reverse gear set PG4 is connected to the planetary carrier PT2 of the second planetary PG2 for shifting to the reverse drive mode.

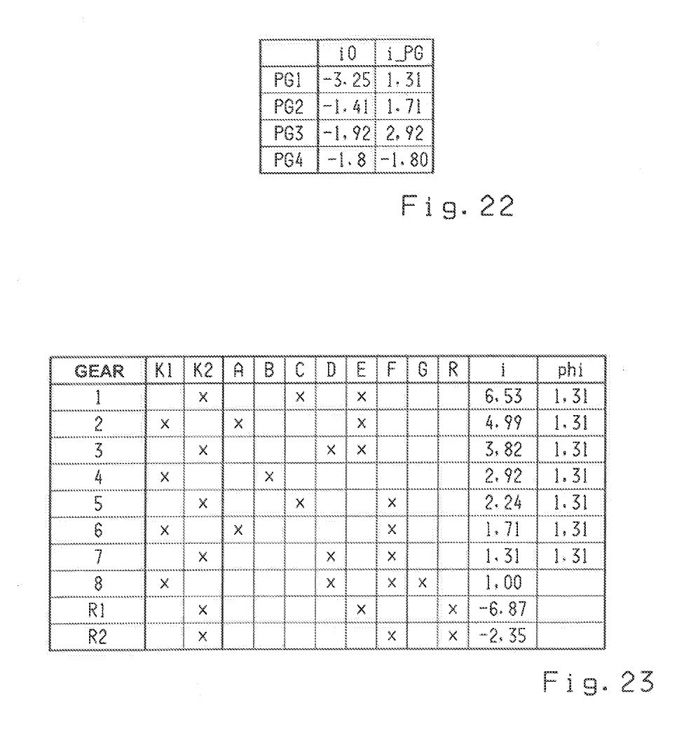

FIGS. 22 and 23 show a possible gear ratio scheme and a shift pattern of this transmission structure. Accordingly, two reverse gears R1, R2 are shiftable via the second clutch K2, the gear ratios of which are nearly identical in comparison to the corresponding forward gears first gear “1” and fifth gear “5”.

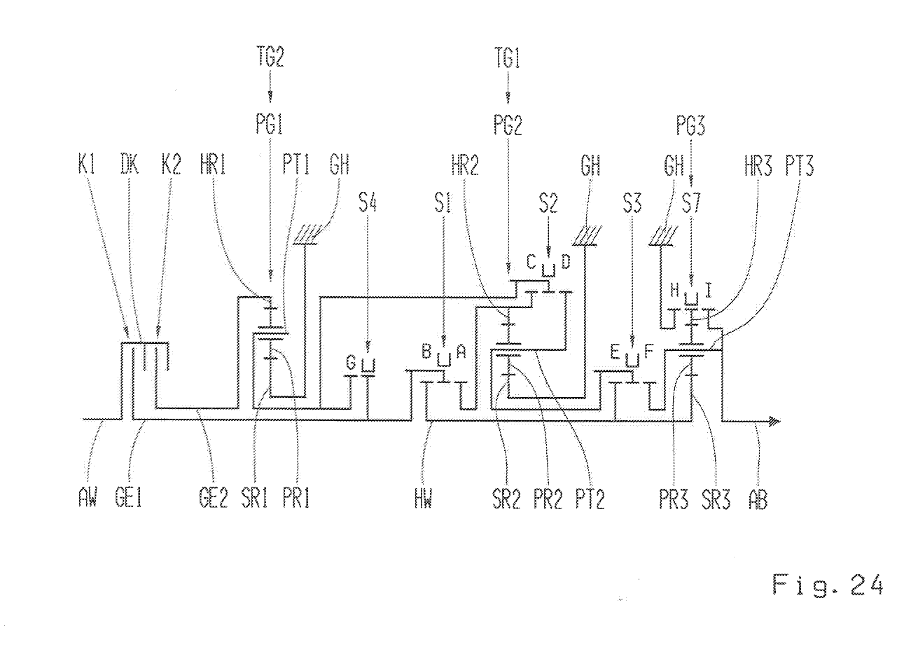

FIG. 24 shows a transmission according to FIG. 4, in which an additional shifting component S7 with two shifting positions H, I is arranged to, at the third planetary gear set PG3, alternately connect its ring gear HR3 to the non-rotating component GH or its planetary carrier gear set PT3. Therefore, this planetary gear set PG3 can optionally be blocked.

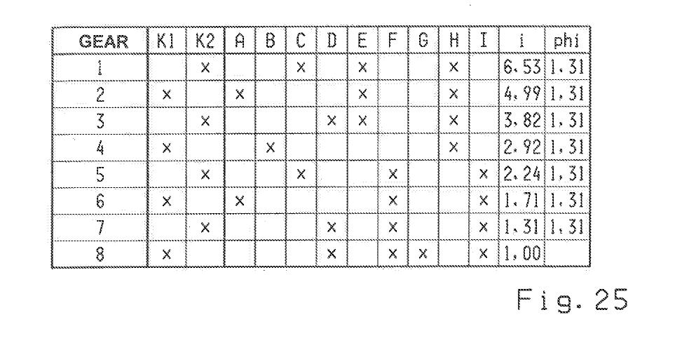

FIG. 25 shows a shift pattern allocated to the transmission according to FIG. 24, which corresponds to the shift pattern according to FIG. 5, and in which the lower four forward gears “1” through “4” are shifted to the effective gear ratio of the third planetary gear set PG3. In the top four forward gears “5” through “8”, however, the third planetary gear set PG3 is a direct drive (seventh shifting component 7 in shifting position I).

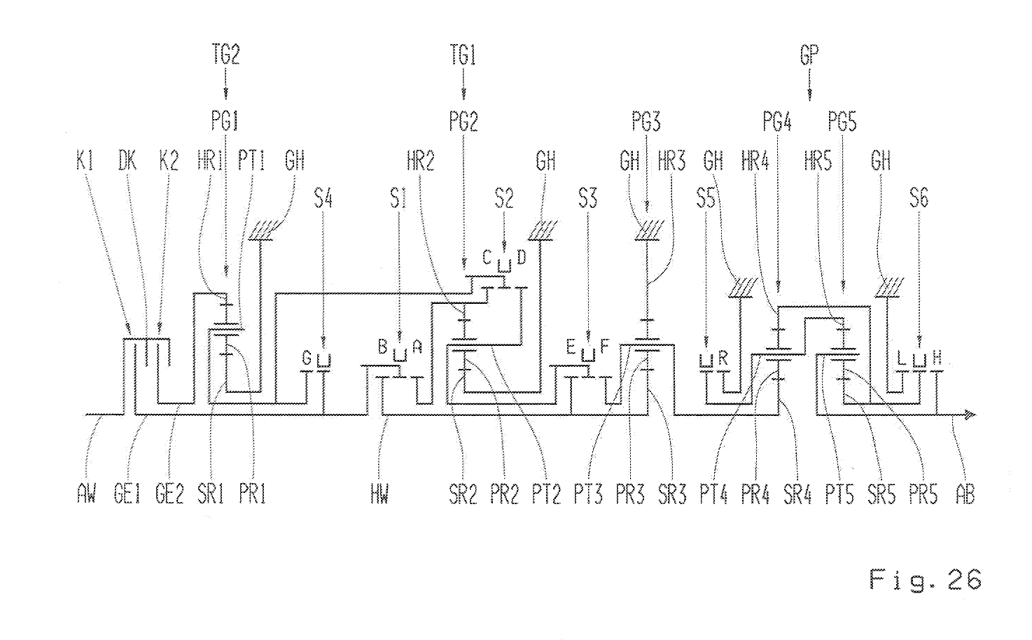

FIG. 26 shows an expansion of the previously shown transmission structure to form an auxiliary transmission. To accomplish this, the third planetary gear set PG3 is configured to a range group GP downstream on the drivetrain, comprising a fourth planetary gear set PG4 formed as a reverse gear set, to which a fifth shifting component is allocated with a shift position R for shifting to a reverse gear group, as well as a fifth planetary gear set PG5, to which a sixth shifting component S6 with two shifting positions L, H is allocated, to shift between a slow and a fast forward gear group.

The ring gear HR4 of the fourth planetary gear set PG4 is connected to the sun gear SR5 of the fifth planetary gear set PG5. The planetary carrier PT4 of the fourth planetary gear set PG4 is connected to the ring gear HR5 of the fifth planetary gear set PG5 and together with this ring gear HR5 via the fifth shifting component S5 for shifting the reverse function can be fixed to the non-rotating component GH. The sun gear SR4 of the fourth planetary gear set PG4 is connected to the planetary carrier PT3 of the third planetary gear set PG3. Furthermore, the sun gear SR5 of the fourth planetary gear set PG4 connected to the ring gear HR4 of the fifth planetary gear set PG5 can be fixed via the sixth shifting component S6 to shift to a lower gear group on non-rotating component GH and can be connected to planetary carrier PT5 of the fifth planetary gear set PG5, whereby the fifth planetary PG5 is blocked.

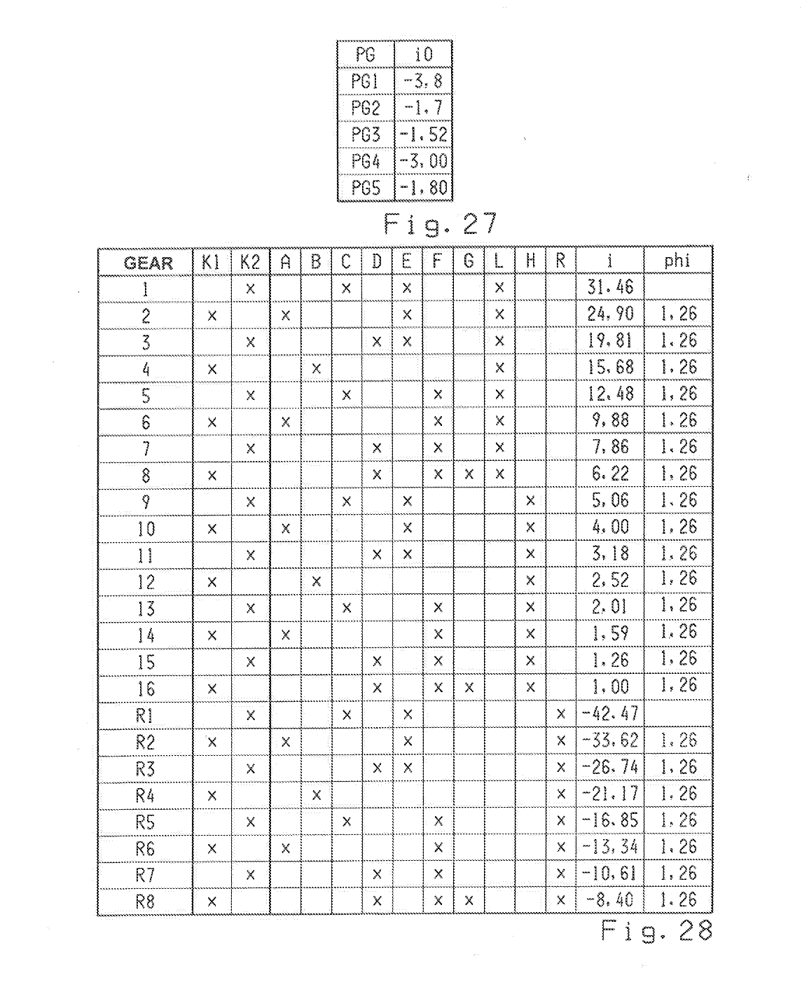

FIG. 27 shows a possible gear ratio table of the five planetary gear sets PG1, PG2, PG3, PG4, PG5. A resulting, possible shift pattern is shown in FIG. 28. Accordingly, a doubling of the number of gears of the double clutch transmission is achieved, so that a total of sixteen forward gears “1” through “16” and eight reverse gears R1 through R8 are shiftable. Traction is interrupted only when shifting the range group GP between the eighth gear “8” and the ninth gear “9”. The gear step phi between the eighth gear “8” and the ninth gear “9” is therefore designed to be lower. All other gear changes can be engaged under load. Due to the increased gear ratio of the fifth planetary gear set PG5, the forward gears “1” through “8” and the reverse gears R1 through R8 have a very short gear ratio in a lower gear group. The transmission expansion according to FIG. 26 is therefore especially suitable for commercial vehicles.

### REFERENCE LIST

A, B, C, D Shift setting
E, F, G, H Shift setting
I, L, R, V Shift setting
AB Drive shaft
B1 Separating element, brake
AW Drive shaft
DK Double clutch
GE1, GE2 Transmission input shaft
GH Torque-proof component, transmission housing
GP Range group
HR1, HR2, HR3 Ring gear
HR4, HR5 Ring gear
HW Main shaft
K1, K2 Separating element, frictional-engagement clutch
PG1, PG2 Planetary gear set
PG3, PG4 Planetary gear set
PG5 Planetary gear set
PR1, PR2, PR3 Planetary gear set
PR4, PR5 Planetary gear set
PT1, PT2, PT3 Planetary carrier, carrier
PT4, PT5 Planetary carrier, carrier
R1, R2, R3, R4 Reverse gear
R5, R6, R7, R8 Reverse gear
S1, S2, S3, S4 Shift element
S5, S6, S7 Shift element
SR1, SR2, SR3 Sun gear
SR4, SR5 Sun gear
TG1, TG2 Sub-transmission
X Separating element, positive-engagement clutch
i Gear ratio
i0 Planetary gear set stationary gear ratio
i_PG Planetary gear set ratio
phi Gear step
“1” to “16” Forward gear

1-16. (canceled)

17. A vehicle transmission comprising:
a drive shaft (AW) having first and second transmission input shafts (GE1, GE2), each of which having a separating element (B1, K1, K2, X) allocated directly or indirectly thereto,
a main shaft (HW),
a drive shaft (AB), and
at least a first, second, and third planetary gear set (PG1, PG2, PG3), each planetary gear set having a ring gear (HR1, HR2, HR3), a sun gear (SR1, SR2, SR3), and a planetary carrier (PT1, PT2, PT3) with planetary gears (PR1, PR2, PR3) as elements, and
a plurality of shift elements (S1, S2, S3, S4, S5, S6, S7) for shifting gear ratios or for shifting drive connections,
wherein the first transmission input shaft (GE1) has a first sub-transmission (TG1) allocated thereto and the second transmission input shaft (GE2) has a second sub-transmission (TG2) allocated thereto, and one of the first and the second sub-transmissions (TG1, TG2) has at least the first planetary gear set (PG1) and the other of the second and the first sub-transmissions (TG1, TG2) has at least the second planetary gear set (PG2),
the first transmission input shaft (GE1) is connectable, on a drive side, to the drive shaft (AW) via a first separating element (K1) which is formed as a clutch,
the first transmission input shaft (GE1) is effectively connectable, on the drive side, to the main shaft (HW) as well as to one or both of the second and the third planetary gear sets (PG2, PG3),
the second transmission input shaft (GE2) is connectable either, directly or indirectly, to the drive shaft (AW) or to the first transmission input shaft (GE1), on the drive side, via a second separating element (K2, X) which is formed as a clutch, or
the second transmission input shaft (GE2) is connected directly to the drive shaft (AW), on the drive side, a second separating element (B1) is formed as a brake by which one of the elements (HR1, PT1, SR1) of the first planetary gear set (PG1) is connected to a torque-proof component (GH) in a locked or detachable manner,
the second transmission input shaft (GE2) is connectable or is directly or indirectly connected, on the drive side, to another one of the elements (HR1, PT1, SR1) of the first planetary gear set (PG1),
the main shaft (HW) is either connected, on the drive side, to an element (HR3, PT3, SR3) of the third planetary gear set (PG3), and an element (HR3, PT3, SR3) of the third planetary gear set (PG3) is connected, on the drive side, to the drive shaft (AB), or the main shaft (HW) is directly connected to the drive shaft (AB) as well as to the element (HR3, PT3, SR3) of the third planetary gear set (PG3), on the drive side, and
at least eight sequentially shiftable forward gears can be shifted by the first and the second sub-transmissions (TG1, TG2) and one of the forward gears is a direct-drive gear.

18. The vehicle transmission according to claim 17, wherein the vehicle transmission is formed as a double-clutch transmission, the first and the second transmission input shafts (GE1, GE2) are arranged coaxially with respect to one another, the first and second separating elements (K1, K2) are formed as frictional-engagement clutches and are connected to the drive shaft (AW), on an input side, in a torsionally resistant manner and effectively connected or effectively connectable to the first or second sub-transmissions (TG1, TG2), on the output side, via one of the first and the second transmission input shafts (GE1, GE2), each of the first and the second sub-transmissions (TG1, TG2) has a group of even or odd gears allocated thereto, and the gears can be at least predominantly sequentially power-shifted.

19. The vehicle transmission according to claim 17, wherein three planetary gear sets (PG1, PG2, PG3) are arranged therein, which can be shifted by first, second, and third shift elements (S1, S2, S3) each having two shift settings (A, B, C, D, E, F) as well as by a fourth shift element (S4) which has one shift setting (G), and the main shaft (HW) is directly connected to the drive shaft (AB),
in the first planetary gear set (PG1), the ring gear (HR1) is connected to the second transmission input shaft (GE2), the sun gear (SR1) is permanently affixed to a torsion-proof component (GH), and the planetary carrier (PT1) can be alternately connected to the ring gear (HR2) of the second planetary gear set (PG2) or to the planetary carrier (PT2) of the second planetary gear set (PG2), via the second shift element (S2),
in the second planetary gear set (PG2), the ring gear (HR2) is connectable to the first transmission input shaft (GE1) by the first shift element (S1), the sun gear (SR2) is permanently affixed to a torsion-proof component (GH), and the planetary carrier (PT2) is connectable to the planetary carrier (PT3) of the third planetary gear set (PG3) by the third shift element (S3), and
in the third planetary gear set (PG3), the ring gear (HR3) is permanently affixed to a torsion-proof component (GH), the sun gear (SR3) is connectable to the planetary carrier (PT2) of the second planetary gear set (PG2) by the third shift element (S3) as well as to the first transmission input shaft (GE1) by the first shift element (S1), and the planetary carrier (PT3) is connected to the drive shaft (AB),
so that at least eight forward gears (“1,” “2,” “3,” “4,” “5,” “6,” “7,” “8”) are sequentially power-shiftable by the first and the second separating element (K1, K2), and the eighth gear (“8”) is implemented as a direct-drive gear, which can be shifted to through a direct connection of the first transmission input shaft (GE1) with the main shaft (HW) and the drive shaft (AB) by the fourth shift element (S4).

20. The vehicle transmission according to claim 17, wherein three planetary gear sets (PG1, PG2, PG3) are arranged therein, which can be shifted to by first, second, and third shift elements (S1, S2, S3) each having two shift settings (A, B, C, D, E, F) as well as by a fourth shift element (S4) having one shift setting (G),
in the first planetary gear set (PG1), the ring gear (HR1) is connected to the second transmission input shaft (GE2), the sun gear (SR1) is permanently affixed to a torsion-proof component (GH), and the planetary carrier (PT1) is alternately connectable to the ring gear (HR2) of the second planetary gear set (PG2) or to the planetary carrier (PT2) of the second planetary gear set (PG2) by the second shift element (S2), as well as connected to the first transmission input shaft (GE) by the fourth shift element (S4),
in the second planetary gear set (PG2), the ring gear (HR2) is connectable to the first transmission input shaft (GE1) by the first shift element (S1), the sun gear (SR2) is permanently affixed to a torsion-proof component (GH), and the planetary carrier (PT2) is connectable to the planetary carrier (PT3) of the third planetary gear set (PG3) by the third shift element (S3), and
in the third planetary gear set (PG3), the ring gear (HR3) is permanently affixed to a torsion-proof component (GH), the sun gear (SR3) is connectable to the planetary carrier (PT2) of the second planetary gear set (PG2) by the third shift element (S3) as well as to the first transmission input shaft (GE1) by the first shift element (S1), and the planetary carrier (PT3) is connected to the drive shaft (AB),
so that at least eight forward gears (“1,” “2,” “3,” “4,” “5,” “6,” “7,” “8”) are sequentially power-shiftable by the first and the second separating elements (B1, K1, K2),
the eighth gear (“8”) is implemented as a direct-drive gear which can be shifted by coupling the first and the second sub-transmissions (TG1, TG2) via engagement of the second, third, and fourth shift element (S2, S3, S4).

21. The vehicle transmission according to claim 17, wherein an additional shift element (S7) is arranged which has at least one shift setting (H, I) by which, in the third planetary gear set (PG3), the ring gear (HR3) is detachably affixed to a torsion-proof component (GH) or can be connected to the planetary carrier (PT3).

22. The vehicle transmission according to claim 17, wherein the first shift element (S1) and the fourth shift element (S4) are combined into a common shift element (S1/S4) having three shift settings (A, B, G).

23. The vehicle transmission according to claim 17, wherein the second planetary gear set (PG2) is arranged radially above the third planetary gear set (PG3), and the second and the third planetary gear sets (PG2, PG3) are constructed so as to be nested axially within one another.

24. The vehicle transmission according to claim 17, wherein the second separating element (B1) is formed as a brake by which the sun gear (SR1) of the first planetary gear set (PG1) is connectable, in a permanent or detachable manner, to a torsion-proof component (GH).

25. The vehicle transmission according to claim 17, wherein the vehicle transmission is formed as a hybrid transmission in which the second transmission input shaft (GE2) is effectively connected to the rotor of an electric motor (EM), and the second separating element (X) is formed as a positive-engagement clutch by which the second transmission input shaft (GE2) is connectable to the first transmission input shaft (GE1).

26. The vehicle transmission according to claim 17, wherein, in order to implement up to four reverse gears (R1, R2, R3, R4), a fourth planetary gear set (PG4), which is formed as a reversal gear set, and a fifth shift element (S5) which has two shift settings (R, V) are arranged, from a drive perspective, upstream of the first planetary gear set (PG1),
the ring gear (HR4) of the fourth planetary gear set (PG4) is connected to the ring gear (HR1) of the first planetary gear set (PG1), the second transmission input shaft (GE2) is connected to the sun gear (SR4) of the fourth planetary gear set (PG4) and is connectable by the fifth shift element (S5) to the planetary carrier (PT4) of the fourth planetary gear set (PG4), and the planetary carrier (PT4) of the fourth planetary gear set (PG4) is affixable to a torsion-proof component (GH) by the fifth shift element (S5).

27. The vehicle transmission according to claim 17, wherein, in order to implement up to four reverse gears (R1, R2, R3, R4), a fourth planetary gear set (PG4), which is formed as a reversal gear set, and a fifth shift element (S5) which has two shift settings (R, V) are arranged, from a drive perspective, upstream of the first planetary gear set (PG1), the ring gear (HR4) of the fourth planetary gear set (PG4) is connected to the planetary carrier (PT1) of the first planetary gear set (PG1), the sun gear (SR4) of the fourth planetary gear set (PG4) is connectable by the fifth shift element (S5) to the second transmission input shaft (GE2), and the planetary carrier (PT4) of the fourth planetary gear set (PG4) is permanently affixed to a torsion-proof component (GH).

28. The vehicle transmission according to claim 17, wherein, in order to implement up to four reverse gears (R1, R2, R3, R4), a fourth planetary gear set (PG4) is formed as a reversal gear set, and a fifth shift element (S5) which has two shift settings (R, V) are arranged, from a drive perspective, upstream of the first planetary gear set (PG1), the ring gear (HR4) of the fourth planetary gear set (PG4) is connected to the planetary carrier (PT1) of the first planetary gear set (PG1), the sun gear (SR4) of the fourth planetary gear set (PG4) is connectable by the fifth shift element (S5) to the second transmission input shaft (GE2), and the planetary carrier (PT4) of the fourth planetary gear set (PG4) is permanently affixed to both a torsion-proof component (GH) and the sun gear (SR1) of the first planetary gear set (PG1).

29. The vehicle transmission according to claim 17, wherein, in order to implement up to four reverse gears (R1, R2, R3, R4), a fourth planetary gear set (PG4), which is formed as a reversal gear set, is positioned, from a drive perspective, upstream of the first planetary gear set (PG1), and a fifth shift element (S5) is present having two shift settings (R, V), which is arranged radially around at least one of the reversal gear set (PG4) and the first planetary gear set (PG1), the ring gear (HR4) of the fourth planetary gear set (PG4) is connected to the planetary carrier (PT1) of the first planetary gear set (PG1), the sun gear (SR4) of the fourth planetary gear set (PG4) is connected to the second transmission input shaft (GE2), and the planetary carrier (PT4) of the fourth planetary gear set (PG4) is affixable by the fifth shift element (S5) to a torsion-proof component (GH).

30. The vehicle transmission according to claim 17, wherein, in order to implement up to four reverse gears (R1, R2, R3, R4), a fourth planetary gear set (PG4), which is formed as a reversal gear set, and a fifth shift element (S5) having two shift settings (R, V) are arranged within the transmission, the fourth planetary gear set (PG4) is arranged radially around the first planetary gear set (PG1) so that the first planetary gear set (PG1) is nested within the fourth planetary gear set (PG4), the ring gear (HR4) of the fourth planetary gear set (PG4) is connected to the planetary carrier (PT1) of the first planetary gear set (PG1), the sun gear (SR4) of the fourth planetary gear set (PG4) is connected to the second transmission input shaft (GE2), and the planetary carrier (PT4) of the fourth planetary gear set (PG4) is affixable by the fifth shift element (S5) to a torsion-proof component (GH).

31. The vehicle transmission according to claim 17, wherein, in order to implement one or two reverse gears (R1, R2), a fourth planetary gear set (PG4), which is formed as a reversal gear set, is arranged between the second and the third planetary gear set (PG2, PG3), the second shift element (S2) and the fifth shift element (S5) are combined into one common shift element (S2/S5) having three shift settings (C, D, R), the ring gear (HR4) of the fourth planetary gear set (PG4) is connected to the planetary carrier (PT2) of the second planetary gear set (PG2), the sun gear (SR4) of the fourth planetary gear set (PG4) is connectable by the fifth shift element (S5) to the planetary carrier (PT1) of the first planetary gear set (PG1), and the planetary carrier (PT4) of the fourth planetary gear set (PG4) is affixed to a torsion-proof component (GH).

32. The vehicle transmission according to claim 17, wherein the vehicle transmission is formed as a double-clutch auxiliary transmission, and a range group (GP) is subordinately connected to the third planetary gear set (PG3) in terms of drive,
comprising a fourth planetary gear set (PG4) formed as a reversal gear set, which is allocated to a fifth shift element (S5) which has a shift setting (R) for shifting to a reverse gear group, as well as a fifth planetary gear set (PG5), which is allocated to a sixth shift element (S6) having two shift settings (L, H) for toggling between a slow and a fast forward gear group such that a total of up to 16 forward gears (“1” to “16”), of which at least 15 are power-shiftable, and up to eight reverse gears (R1 to R8), all of which are power-shiftable, are shiftable,
in the fourth planetary gear set (PG4), the ring gear (HR4) of the fourth planetary gear set (PG4) is connected to the sun gear (SR5) of the fifth planetary gear set (PG5), the sun gear (SR4) of the fourth planetary gear set (PG4) is connected to the planetary carrier (PT3) of the third planetary gear set (PG3), and the planetary carrier (PT4) of the fourth planetary gear set (PG4) is connected to the ring gear (HR5) of the fifth planetary gear set (PG5) and affixable by the fifth shift element (S5) to a torsion-proof component (GH), and
in fifth planetary gear set (PG5), the sun gear (SR5) of the fifth planetary gear set (PG5) is alternately affixable by the sixth shift element (S6) to a torsion-proof component (GH) or connected to the planetary carrier (PT5) of the fifth planetary gear set (PG5), and the planetary carrier (PT5) of the fifth planetary gear set (PG5) is connected to the drive shaft (AB).
